(19) United States
(12) Patent Application Publication
(10) Pub. No.: US 2026/0161145 A1
(43) Pub. Date: Jun. 11, 2026

(54) CONTROL SYSTEM WITH NEURAL NETWORK PREDICTOR INCORPORATING FIRST PRINCIPLES

(71) Applicant: Imubit Israel Ltd., Modiin (IL)

(72) Inventors: Matanya Yechiel Beery, Tzur Hadassa (IL); Ran Adi, Shoham (IL); Alexander James Braun, Houston, TX (US); Yarden Sheffer, Tel Aviv (IL); Nadav Cohen, Yavne (IL)

(73) Assignee: Imubit Israel Ltd., Modiin (IL)

(21) Appl. No.: 18/976,116

(22) Filed: Dec. 10, 2024

(51) Int. Cl. G05B 13/04; G05B 13/02; G06N 3/092

(52) U.S. Cl. CPC G05B 13/048; G05B 13/027; G06N 3/092

(57) ABSTRACT

A predictive control system for a plant includes a predictor model trainer and a predictive controller. The predictor model trainer is configured to train a predictor model using a loss function including (i) a first error loss term based on an error between predicted values of controlled variables (CVs) generated by the predictor model and historical values of the CVs in historical state data and (ii) a second error loss term based on the predicted values of the CVs and physical relationships involving the CVs. The predictive controller is configured to control operation of the plant using the trained predictor model.

### BACKGROUND

The present disclosure relates generally to a control system for a plant (e.g., an oil refinery, a chemical processing facility, etc.) including one or more controllable systems or processes (e.g., oil refining equipment such as an atmospheric distillation unit, vacuum distillation unit, coker, fluid catalytic cracker unit; chemical processing equipment such as chemical reactors, grinders, mixers, dryers, etc.). The present disclosure relates more particularly to predictive control systems that generate predictive models (e.g., neural network models) and use the predictive models to operate controllable systems or processes.

System identification is the process of generating a prediction model that allows for the prediction of future system states or system outputs. Because the physical phenomena that govern some systems are often complex, nonlinear, and poorly understood, it may be difficult to construct “white-box” prediction models for such systems. Accordingly, system identification can be used to generate or train a prediction model (e.g., determine values for model parameters, weights, etc.) based on measured and recorded data from the real system and any external influences (e.g., controllable inputs to the system, uncontrolled disturbances, etc.). System identification can be performed using a variety of different methods including, for example, “black-box” methods in which a system is viewed in terms of its inputs and outputs without requiring any knowledge of its inner workings or “gray-box” methods in which the prediction model is based on both insight into the system and experimental data. The data set used to perform the system identification process is often referred to as training data and may include historical data gathered from the system or other data sources.

In some cases, system identification starts by using an initial or untrained version of the prediction model to predict future states or outputs of the system given the initial state of the system and a set of inputs to the system over time. The predictions from the model can be compared to actual data from the system (e.g., historical data) during an offline learning process and the error between the model predictions and the actual data can be evaluated. The model parameters can be adjusted and the process repeated (e.g., iteratively) until the model predictions align with the actual data from the system to the desired degree of accuracy. A variety of different techniques for adjusting the model parameters to reduce model error are known in the art. However, regardless of the technique used, it can be difficult to learn the true relationship between the inputs to the system and the system states or outputs due to the presence of noise (e.g., measurement noise, process noise, etc.), unmeasured disturbances, or other factors that often cause the model to misrepresent the actual relationships between variables.

One type of prediction model which can be used in a variety of systems is a neural network model. System identification can be performed to train a neural network model using historical data from the system. However, because the historical data may not accurately represent the true relationships between input and output variables in some scenarios, training the neural network model in this manner can lead to inaccuracies in the predictions generated by the neural network model. This can occur if the historical data lack sufficient generality (e.g., the historical data do not fully represent all operating regimes). For example, if two variables always have the same trend or relationship in the historical data but do not always behave in that manner in general, the neural network model may have poor predictions when the system is operated in a regime in which those same variables exhibit a different trend or relationship. As another example, the neural network model may learn an incorrect relationship between variables due to noise or other inaccuracies in the historical data used to train the model.

In some cases, using a prediction model that does not accurately represent the true relationships between variables in a physical system can lead to predictions that are physically implausible. Accordingly, a controller built on top of such a prediction model could take advantage of the imprecision in the prediction model and optimize or maintain bounds in a physically implausible way that will not yield desired or realistic results when applied to the real system. The systems and methods of the present disclosure address this challenge.

### SUMMARY

One implementation of the present disclosure is a predictive control system for a plant. The predictive control system includes a predictor model trainer configured to obtain historical state data including at least historical values of one or more manipulated variables (MVs) provided as inputs to the plant and historical values of one or more controlled variables (CVs) affected by operating the plant using the historical values of the MVs. The predictor model trainer is configured to use a predictor model to generate predicted values of the CVs based on the historical state data. The predictor model trainer is configured to generate a loss function including (i) a first error loss term based on an error between the predicted values of the CVs and the historical values of the CVs in the historical state data and (ii) a second error loss term based on the predicted values of the CVs and physical relationships involving the CVs. The predictor model trainer is configured to train the predictor model using the loss function. Training the predictor model may include adjusting the predictor model to drive the loss function toward an extremum and transforms the predictor model into a trained predictor model. The predictive control system further includes a predictive controller configured to control operation of the plant using the trained predictor model.

In some embodiments, controlling operation of the plant includes operating equipment of the plant using new values of the MVs generated by the predictive controller using the trained predictor model.

In some embodiments, controlling operation of the plant includes providing proposed values of the MVs as an input to the trained predictor model, using the trained predictor model to generate new predicted values of the CVs based on the proposed values of the MVs, evaluating a reward function using the new predicted values of the CVs, and adjusting the proposed values of the MVs to drive the reward function toward an extremum.

In some embodiments, the physical relationships involving the CVs include one or more material balance relationships. The predictor model trainer may be configured to generate the second error loss term by generating one or more material balance equations expressing conservation of a physical quantity represented by one or more of the CVs and one or more other variables and calculating a value of the second error loss term based on an amount by which the predicted values of the CVs violate the material balance equations.

In some embodiments, the physical relationships involving the CVs include one or more correlations between the MVs and the CVs. The predictor model trainer may be configured to generate the second error loss term by generating a manipulated state of the plant including one or more adjusted values of the MVs relative to the historical values of the MVs and using the predictor model to generate a predicted reaction to the manipulated state. The predicted reaction may include one or more new predicted values of the CVs based on the adjusted values of the MVs. The predictor model trainer may be configured to generate the second error loss term by calculating a value of the second error loss term based on whether the predicted reaction to the manipulated state is consistent with the one or more correlations defined by the physical relationships.

In some embodiments, the physical relationships involving the CVs include one or more gradients involving the CVs. The predictor model trainer may be configured to generate the second error loss term by generating one or more expected gradients based on the physical relationships. Each expected gradient may be a gradient between a CV and another variable upon which the CV depends according to the physical relationships. The predictor model trainer may be configured to generate the second error loss term by generating one or more predicted gradients based on the predicted values of the CVs generated by the predictor model and the historical state data. Each predicted gradient may include a gradient between the predicted values of a CV and historical values of another variable in the historical state data. The predictor model trainer may be configured to generate the second error loss term by calculating a value of the second error loss term based on whether the one or more predicted gradients are consistent with the one or more expected gradients based on the physical relationships.

In some embodiments, the physical relationships involving the CVs include empirical relationships involving the CVs. The predictor model trainer may be configured to generate the second error loss term by obtaining empirical data comprising observed or calculated values of one or more of the CVs and one or more other variables and generating one or more empirical curves based on the empirical data. Each empirical curve may define an empirically derived relationship between one or more of the CVs and the one or more other variables. The predictor model trainer may be configured to generate the second error loss term by calculating a value of the second error loss term based on an error between the predicted values of the CVs generated by the predictor model and the one or more empirical curves.

In some embodiments, the predictor model is a neural network model and training the predictor model includes adjusting weights or biases between neurons or layers of the neural network model.

Another implementation of the present disclosure is a method for controlling operation of a plant. The method includes training a predictor model using historical state data including at least historical values of one or more manipulated variables (MVs) provided as inputs to the plant and historical values of one or more controlled variables (CVs) affected by operating the plant using the historical values of the MVs, using the predictor model to generate predicted values of the CVs based on proposed values of the MVs, generating a reward function including (i) a first reward term based on the predicted values of the CVs and (ii) a second reward term based on physical relationships involving the CVs, adjusting the proposed values of the MVs to generate new values of the MVs that drive the reward function toward an extremum, and controlling operation of the plant using the new values of the MVs.

In some embodiments, training the predictor model includes using the predictor model to generate additional predicted values of the CVs based on the historical state data.

In some embodiments, training the predictor model further includes generating a loss function including (i) a first error loss term based on an error between the additional predicted values of the CVs and the historical values of the CVs in the historical state data and (ii) a second error loss term based on the additional predicted values of the CVs and the physical relationships involving the CVs. Training the predictor model may further include adjusting parameters of the predictor model to drive the loss function toward an extremum.

In some embodiments, the physical relationships involving the CVs include one or more material balance relationships. Generating the second reward term may include generating one or more material balance equations expressing conservation of a physical quantity represented by one or more of the CVs and one or more other variables and calculating a value of the second reward term based on an amount by which the predicted values of the CVs violate the material balance equations.

In some embodiments, the physical relationships involving the CVs include one or more correlations between the MVs and the CVs. Generating the second reward term may include generating a manipulated state of the plant including one or more adjusted values of the MVs relative to the historical values of the MVs and using the predictor model to generate a predicted reaction to the manipulated state. The predicted reaction may include one or more new predicted values of the CVs based on the adjusted values of the MVs. Generating the second reward term may include calculating a value of the second reward term based on whether the predicted reaction to the manipulated state is consistent with the one or more correlations defined by the physical relationships.

In some embodiments, the physical relationships involving the CVs include one or more gradients involving the CVs. Generating the second reward term may include generating one or more expected gradients based on the physical relationships. Each expected gradient may include a gradient between a CV and another variable upon which the CV depends according to the physical relationships. Generating the second reward term may include generating one or more predicted gradients based on the predicted values of the CVs generated by the predictor model and the historical state data. Each predicted gradient may include a gradient between the predicted values of a CV and historical values of another variable in the historical state data. Generating the second reward term may include calculating a value of the second reward term based on whether the one or more predicted gradients are consistent with the one or more expected gradients based on the physical relationships.

In some embodiments, the physical relationships involving the CVs include empirical relationships involving the CVs. Generating the second reward term may include obtaining empirical data comprising observed or calculated values of one or more of the CVs and one or more other variables and generating one or more empirical curves based on the empirical data. Each empirical curve may define an empirically derived relationship between one or more of the CVs and the one or more other variables. Generating the second reward term may include calculating a value of the second reward term based on an error between the predicted values of the CVs generated by the predictor model and the one or more empirical curves.

In some embodiments, the predictor model is a neural network model and training the predictor model includes adjusting weights or biases between neurons or layers of the neural network model.

Another implementation of the present disclosure is a predictive control system for a plant. The predictive control system includes one or more processing circuits configured to obtain historical state data comprising at least historical values of one or more manipulated variables (MVs) provided as inputs to the plant and historical values of one or more controlled variables (CVs) affected by operating the plant using the historical values of the MVs, use a neural network predictor to generate predicted values of the CVs based on the historical state data, generate a loss function comprising (i) a first error loss term based on an error between the predicted values of the CVs and the historical values of the CVs in the historical state data and (ii) a second error loss term based on the predicted values of the CVs and physical relationships involving the CVs, and train the neural network predictor using the loss function. Training the neural network predictor includes adjusting the neural network predictor to drive the loss function toward an extremum and transforms the neural network predictor into a trained neural network predictor. The one or more processing circuits are further configured to use the trained neural network predictor to monitor or control operation of the plant.

In some embodiments, the physical relationships involving the CVs include one or more material balance relationships. The one or more processing circuits may be configured to generate the second error loss term by generating one or more material balance equations expressing conservation of a physical quantity represented by one or more of the CVs and one or more other variables and calculating a value of the second error loss term based on an amount by which the predicted values of the CVs violate the material balance equations.

In some embodiments, the physical relationships involving the CVs include one or more correlations between the MVs and the CVs. The one or more processing circuits may be configured to generate the second error loss term by generating a manipulated state of the plant including one or more adjusted values of the MVs relative to the historical values of the MVs and using the neural network predictor to generate a predicted reaction to the manipulated state. The predicted reaction may include one or more new predicted values of the CVs based on the adjusted values of the MVs. The one or more processing circuits may be configured to generate the second error loss term by calculating a value of the second error loss term based on whether the predicted reaction to the manipulated state is consistent with the one or more correlations defined by the physical relationships.

In some embodiments, the physical relationships involving the CVs include one or more gradients involving the CVs. The one or more processing circuits may be configured to generate the second error loss term by generating one or more expected gradients based on the physical relationships. Each expected gradient may include a gradient between a CV and another variable upon which the CV depends according to the physical relationships. The one or more processing circuits may be configured to generate the second error loss term by generating one or more predicted gradients based on the predicted values of the CVs generated by the neural network predictor and the historical state data. Each predicted gradient may include a gradient between the predicted values of a CV and historical values of another variable in the historical state data. The one or more processing circuits may be configured to generate the second error loss term by calculating a value of the second error loss term based on whether the one or more predicted gradients are consistent with the one or more expected gradients based on the physical relationships.

In some embodiments, the physical relationships involving the CVs include empirical relationships involving the CVs. The one or more processing circuits may be configured to generate the second error loss term by obtaining empirical data including observed or calculated values of one or more of the CVs and one or more other variables and generating one or more empirical curves based on the empirical data. Each empirical curve may define an empirically derived relationship between one or more of the CVs and the one or more other variables. The one or more processing circuits may be configured to generate the second error loss term by calculating a value of the second error loss term based on an error between the predicted values of the CVs generated by the neural network predictor and the one or more empirical curves.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a control system including a plant and a plant controller, where the plant controller includes a predictor model trainer which trains a predictor model using historical data and a predictive controller which uses the predictor model to operate the plant, according to an exemplary embodiment.

FIG. 2 is a block diagram illustrating the predictor model trainer of FIG. 1 in greater detail including a physical relationships (PHR) error evaluator which uses physical relationships between variables to generate a loss function based on the PHR error, according to an exemplary embodiment.

FIG. 3 is a block diagram illustrating the PHR error evaluator of FIG. 2 in greater detail in which the physical relationships represent material balances between manipulated variables and controlled variables in the system, according to an exemplary embodiment.

FIG. 4 is a block diagram illustrating unrealistic predictions made by the predictor model of FIG. 1 when the PHR error evaluator of FIG. 3 is not used to train the predictor model, according to an exemplary embodiment.

FIG. 5 is a block diagram illustrating realistic predictions made by the predictor model of FIG. 1 when the PHR error evaluator of FIG. 3 is used to train the predictor model, according to an exemplary embodiment.

FIG. 6 is a block diagram illustrating the PHR error evaluator of FIG. 2 in greater detail in which the physical relationships represent expected trends or relationships between manipulated variables and controlled variables, according to an exemplary embodiment.

FIGS. 7A-7B are graphs illustrating how the PHR error evaluator of FIG. 6 generates manipulated states and predicted reactions from a base state of the system, according to an exemplary embodiment.

FIG. 8 is a block diagram illustrating the PHR error evaluator of FIG. 2 in greater detail in which the physical relationships represent expected gradients between manipulated variables and controlled variables in the system, according to an exemplary embodiment.

FIGS. 9A-9B are graphs illustrating how the PHR error evaluator of FIG. 8 generates improves the predictions made by the predictor model by accounting for expected gradients between variables, according to an exemplary embodiment.

FIG. 10 is a block diagram illustrating the PHR error evaluator of FIG. 2 in greater detail in which the physical relationships represent empirical relationships between manipulated variables and controlled variables in the system, according to an exemplary embodiment.

FIGS. 11A-11B are graphs illustrating how the PHR error evaluator of FIG. 10 generates improves the predictions made by the predictor model by accounting for empirical relationships between variables, according to an exemplary embodiment.

FIG. 12 is a block diagram illustrating how the predictor model of FIG. 1 can be trained to generate a gains matrix, according to an exemplary embodiment.

FIG. 13 is a block diagram illustrating the PHR error evaluator of FIG. 2 in greater detail in which the physical relationships represent relationships between coefficients of the gains matrix of FIG. 12, according to an exemplary embodiment.

FIGS. 14A-14B are graphs illustrating an improvement in prediction spaces and optimization spaces that result from using the PHR error loss function to train the predictor model, according to an exemplary embodiment.

FIG. 15 is a flowchart of a process which can be performed by the plant controller of FIG. 1 to train a predictor model and use the predictor model to control a plant, according to an exemplary embodiment.

### DETAILED DESCRIPTION

### Overview

Referring generally to the FIGURES, control systems and methods with a neural network incorporating first principles are shown, according to various exemplary embodiments. The systems and methods described herein can be used to generate or train predictor models of a plant (e.g., a controlled system or process) during an offline training phase and then use the predictive models to control online operation of the plant. The predictor models can be neural network models or any other type of prediction model in various embodiments. The predictor models can also or alternatively be used for purposes other than controlling the plant, such as analytics, diagnostics, simulations, generating recommendations, etc.

In conventional model training processes, the prediction error of the model is calculated relative to a ground truth (e.g., actual values of the variables predicted by the model) using and the model is iteratively adjusted until the model predictions sufficiently correspond to the ground truth. However,

Advantageously, the systems and methods of the present disclosure improve upon conventional model training processes by incorporating another source of ground truth into the training process based on first principles. First principles are calculations (e.g., equations, relationships, predictions, etc.) that are built on a fundamental understanding of the underlying phenomena (e.g., physio-chemical phenomena) that govern the relationships between the variables provided as inputs or outputs of the plant. These calculations can include reactor kinetics, internal and external mass or heat transfer, material balances (e.g., mass balances, volume balances, energy balances, etc.), or any other type of relationship based on physical principles. In general, first principles represent physical relationships between variables that are driven by laws of physics, a priori knowledge of the physical phenomena that govern the controlled system or process, and/or empirically observed relationships between variables.

By incorporating first principles, the prediction error of the model can be expressed using a loss function having at least two terms as shown in the following equation:

$$Loss = {Loss}_{error} + λ {Loss}_{PHR}$$

where Loss is the overall value of the loss function, Lossₑᵣᵣₒᵣ is the loss based on the error in the model-predicted values relative to historical values, Loss_{PHR} is the loss based on the error in the model-predicted values relative to expected values based on physical relationships, and λ is a weight (λ>0) used to assign a relative importance to Loss_{PHR} relative to Lossₑᵣᵣₒᵣ. The first term Lossₑᵣᵣₒᵣ can be calculated using existing techniques for quantifying model error (e.g., mean square error, mean absolute error, etc.), whereas the second term Loss_{PHR} can be defined and calculated using the new techniques described in detail throughout the present disclosure.

For systems where first principles are known for process units of a plant, the physical relationships error loss term Loss_{PHR} can be used to require the predictor model to follow the known equations. Including this term in the overall loss function Loss assists the predictor model in accurately modeling real-world problems. Advantageously, by accurately predicting the process dynamics of the plant while enforcing physical relationships based on first principles, the predictor model learns to better understand the real-time impacts of reactions, mass/heat transfer, and kinetics across different process units of the plant. This leads to improved controller optimization of throughout any process units of the plant with known first principles. These and other features are described in greater detail below.

Control System with Plant Controller and Predictor Model

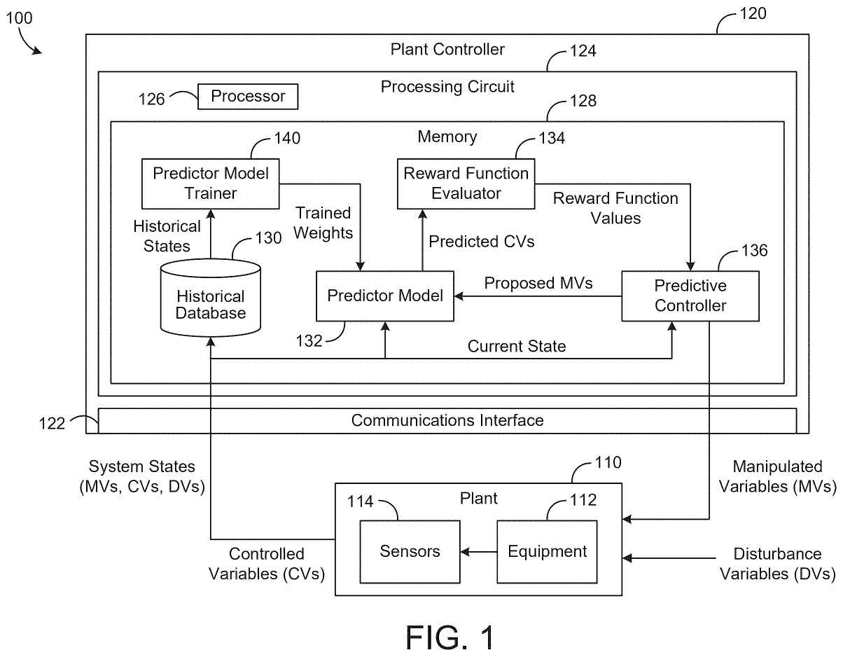

Referring now to FIG. 1, a block diagram of a control system 100 is shown, according to an exemplary embodiment. Control system 100 is shown to include a plant 110 and a plant controller 120. A plant in control theory is the combination of a process and controllable equipment capable of affecting the process. Plant 110 can include any type of controllable system or process. In some embodiments, plant 110 includes an oil refinery system which operates to transform crude oil or other crude petroleum products into more useful products such as gasoline, petrol, kerosene, jet fuel, etc. Several examples of oil refinery systems which can be used as plant 110 are described in detail in U.S. patent application Ser. No. 16/888,128 filed May 29, 2020, U.S. patent application Ser. No. 16/950,643 filed Nov. 17, 2020, U.S. patent application Ser. No. 17/308,474 filed May 5, 2021, U.S. patent application Ser. No. 17/384,660 filed Jul. 23, 2021, U.S. patent application Ser. No. 17/831,227 filed Jun. 2, 2022, and U.S. patent application Ser. No. 18/403,179 filed Jan. 3, 2024, all of which are incorporated by reference herein in their entireties. However, it should be understood that plant 110 is not limited to oil refinery systems and can include any of a wide variety of controllable systems or processes (e.g., mechanical processes, chemical processes, electrical processes, manufacturing processes, etc.) across a variety of different industries or applications.

Plant 110 is shown to include equipment 112 and sensors 114. Equipment 112 can include any type of controllable equipment capable of affecting the process represented by plant 110. Examples of equipment 112 include valves, actuators, pumps, fans, burners, chillers, robotic assemblies, mixers, or any other type of equipment. The particular type or types of equipment 112 included in plant 110 depends on the type of controllable system or process and may include any type of equipment 112 suitable for use in that system or process. For example, in an oil refinery system, equipment 112 may include oil tanks, atmospheric distillation units (ADUs), vacuum distillation units (VDUs), coker subsystems, fluid catalytic cracker units (FCCUs), hydrocracking units (HUs), or any other type of equipment suitable for oil refinery operations. Sensors 114 can include any of a wide variety of sensors (e.g., meters, measurement devices, sensing devices, etc.) capable of monitoring the controllable system or process represented by plant 110. For example, sensors 114 can include temperature sensors, pressure sensors, weight sensors, chemical sensors, motion sensors, proximity sensors, magnetic sensors, ultrasonic transducers, capacitive sensors, light sensors, or any other type of sensor capable of measuring a variable state or condition of plant 110.

The state of plant 110 at a given time or over a given time period (e.g., a time window) can be represented by a set of manipulated variables (MVs), controlled variables (CVs), and disturbance variables (DVs). MVs may include any variables that can be manipulated or adjusted by plant controller 120, for example to cause a desired change in the operation of plant 110. MVs may include control signals that are provided as inputs to equipment 112, setpoints that are provided as inputs to lower level controllers for equipment 112, or other variables that can be directly manipulated (e.g., adjusted, set, modulated, etc.) by plant controller 120. Examples of MVs in system 100 in the context of an oil refinery system can include the temperatures or pressures within an atmospheric distillation unit, vacuum distillation unit, fractionator, coke drums, and/or furnace, the positions of various valves, the feed rates of crude oil, residual oil, and/or coking vapor into various equipment 112, or any other controllable variable parameter that can be adjusted to control the operation of plant 110, or any combination thereof. MVs may have a direct or indirect effect on the values of the CVs which are affected by operating equipment 112 of plant 110.

In some embodiments, MVs include variables that are provided as inputs to plant 110 and affect the values of the CVs, but are not necessarily controlled or adjusted by plant controller 120. For example, some MVs may have values set by another system or device outside the control of plant controller 120 (e.g., a supervisory controller, a remote system or device, a user device, etc.). In some embodiments, MVs include uncontrolled variables or disturbances. For example, some MVs may be measured or observed (e.g., outside air temperature, input oil feed composition, etc.) and may have an impact on the operation of plant 110 and the resulting values of the CVs, but may be treated as uncontrolled inputs to plant 110. In this regard, some MVs may be similar to DVs and may include any of the DVs described in greater detail below.

CVs may include one or more variables that can be controlled by operating equipment 112 of plant 110. In some embodiments, the CVs represent the outputs of plant 110 and are affected by the process represented by plant 110. The CVs may quantify the performance of plant 110 and/or quality of one or more variables affected by plant 110. Examples of CVs may include measured values (e.g., temperature, pressure, energy consumption, etc.), calculated values (e.g., efficiency, coefficient of performance (COP), etc.), yield of one or more oil products produced by plant 110, error of a measured or calculated variable relative to a setpoint or target value, or any other values that characterize the performance or state of a controllable system or process. Some CVs may represent quantities that are not capable of being directly manipulated by plant controller 120 (and thus do not qualify as MVs), but rather can be affected by manipulating the corresponding MVs that affect the CVs by operation of plant 110. CVs may include the volumes, flow rates, mass, or other variables that quantify the amount of the various output products produced by plant 110 and/or any metrics based on such variables (e.g., error relative to a setpoint or target).

DVs may represent disturbances that can cause CVs to deviate from their respective set points or otherwise affect the operation of plant 110. Examples of DVs include measurable or unmeasurable disturbances to system 100 such as outside air temperature, outside air humidity, uncontrolled sources of heat transfer, etc. DVs are typically not controllable, but may be measurable or unmeasurable depending on the type of disturbance. Any of the variables described as MVs may be DVs in some embodiments in which plant controller 120 cannot control those variables. Similarly, any of the variables described as DVs may be MVs in some embodiments in which plant controller 120 can control those variables. Examples of DVs in an oil refinery system can include input oil feed composition, hydrogen flow rate, reactor pressure, catalyst age, separation and/or fractionation section temperatures and pressures, reactor temperature differentials, intermediate flow rates, upstream unit process operating conditions, or any combination thereof, to the extent that such variables are not directly controllable by plant controller 120.

In some embodiments, one or more of the CVs, DVs, or MVs are not provided by actual sensors, but rather are virtual variables which are calculated from one or more other CVs, DVS, or MVs and/or from one or more other sensor readings. In various embodiments, the virtual variables can be defined as linear or non-linear functions of one or more other variables or sensor readings.

The CVs may include one or more virtual controlled variables that represent a signal sampled at a low rate, for example, lower than once every 10, 50, 100 or 1,000 time points in which regular CVs are measured. In some embodiments, the values at the intermediate time points are estimated by interpolation from the values at the measured time points. Alternatively or additionally, machine learning is applied to the values of the CVs and possibly the MVs and/or DVs at the time points at which the low-rate sampled variables were sampled, to determine a connection between the other controlled, disturbance and/or manipulated variables and the low-rate sampled variables. A resultant function can then be applied to the values of the CVs, DVs, and/or MVs at the time points for which the low-rate sampled variable was not measured to provide inferred values for these times of the low-rate sampled variables. Alternatively to the low-rate sampled variables being calculated as a function of the other variables at a single time point, the values of the low-rate sampled variables can be calculated based on values of the other variables in a plurality of time points in the vicinity of the time point for which the values of the low-rate sampled variables are calculated. For example, a machine learning device can be trained to predict low-rate sampled variable values at each given time point, based on 10-20 time points before and/or after the given time point. In some embodiments, the values of the low-rate sampled variables are inferred via a combination of interpolation from the sampled values and the resultant function from the machine learning.

The time points for which values are stored in historical database 130 may include time points separated by regular periods, such as every 5 seconds, 15 seconds, half minute, minute, five minutes or fifteen minutes. The time points for which values are stored in historical database 130 may span over a relatively long period, for example, at least a week, at least a month, at least a year or even at least 3 years or more. In some embodiments, values are collected for at least 1,000 time points, for at least 10,000 time points, for at least 100,000 time points or even for at least a million time points. It is noted that if values are collected every fifteen seconds, values for 5,760 time points are collected every day, such that in some embodiments, more than 2 million time points per year are collected and considered by plant controller 120. In some embodiments, values for time points of at least 1 year, at least 3 years or even at least 5 years are used by plant controller 120 in generating predictor model 132 and/or predictive controller 136.

The number of variables having values at each time point may be relatively small, for example less than 10 variables or even less than five variables, or may be very large, for example more than 50 variables, more than 100 variables, more than 1,000 variables or even more than 10,000 variables. Additional details regarding the number and types of variables which can be used in system 100 are described in detail in U.S. patent application Ser. No. 18/081,721 filed Dec. 15, 2022, the entire disclosure of which is incorporated by reference herein.

In operation, the MVs can be generated by plant controller 120 and provided as inputs to plant 110. In some embodiments, plant controller 120 provides the MVs as the desired values of the corresponding variables represented by the MVs. For example, if a given MV represents the feed rate of an input oil feed into a reactor, the value of the MV can be provided as a volume or mass flow rate of the input oil feed (e.g., kg/s, m³/s, etc.) representing the desired rate at which to feed the oil into the reactor. In other embodiments, plant controller 120 provides the MVs as “MV moves” which indicate changes in the MVs relative to their previous values. For example, if the previous mass flow rate of the input oil feed represented by an MV was 2 kg/s and the desired feed rate is 3 kg/s, plant controller 120 may provide an MV move of +1 kg/s for the corresponding MV to cause plant 110 to increase the mass flow rate from 2 kg/s to 3 kg/s. Values of the CVs and the DVs can similarly be provided as either the actual values of the corresponding variables or as “CV moves” or “DV moves” respectively.

The values of the MVs affect operation of plant 110 and thus influence the values of the CVs provided as outputs of plant 110. Plant 110 and the values of the CVs can also be affected by the DVs, which are shown in FIG. 1 as additional (uncontrolled) inputs to plant 110 but not directly controlled by plant controller 120. The set of values of the MVs, CVs, and DVs at a given time or over a given time period (i.e., a window of time) and define the state of system 100 at that time/period, referred to herein as the “system state.” The system state can be observed and/or recorded at each time or each window of time and stored in a historical database 130. Although historical database 130 is shown as a component of plant controller 120, it is contemplated that historical database 130 can be separate from plant controller 120 in some embodiments. The real-time state of system 100 can also be provided as an input to plant controller 120 during online operation of plant 110 and used by various components of plant controller 120 as described herein to generate the values of the MVs.

Still referring to FIG. 1, plant controller 120 is shown to include a communications interface 122 and a processing circuit 124. Communications interface 122 can be or include wired or wireless communications interfaces (e.g., jacks, antennas, transmitters, receivers, transceivers, wire terminals, etc.) for conducting data communications. In various embodiments, communications via communications interface 122 can be direct (e.g., local wired or wireless communications) or via a communications network (e.g., a WAN, the Internet, a cellular network, etc.). For example, communications interface can include an Ethernet card and port for sending and receiving data via an Ethernet-based communications link or network. In another example, communications interface 122 can include a Wi-Fi transceiver for communicating via a wireless communications network. In another example, communications interface 122 can include cellular or mobile phone communications transceivers.

Processing circuit 124 is shown to include a processor 126 and memory 128. Processing circuit 124 can be communicably connected to communications interface 122 such that processing circuit 124 and the various components thereof can send and receive data via communications interface 122. Processor 126 can be implemented as a general-purpose processor, an application specific integrated circuit (ASIC), one or more field programmable gate arrays (FPGAs), a group of processing components, or other suitable electronic processing components. In some embodiments, processor 126 includes one or more processors which can be located within a single physical device or distributed across multiple physical devices or systems.

Memory 128 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. Memory 128 can be or include volatile memory or non-volatile memory. Memory 128 can include database components, object code components, script components, or any other type of information structure for supporting the various activities and information structures described in the present disclosure. According to an example embodiment, memory 128 is communicably connected to processor 126 via processing circuit 124 and includes computer code for executing (e.g., by processing circuit 124 and/or processor 126) one or more processes described herein.

Although plant controller 120 and the various components thereof (i.e., communications interface 122, processing circuit 124, processor 126, and memory 128) are shown as components of a single device in FIG. 1 for ease of illustration, it is contemplated that plant controller 120 can include multiple separate systems or devices that can be distributed across multiple physical locations in some embodiments. For example, some portions of plant controller 120 can be implemented on-site (e.g., at the same location as plant 110) whereas other portions of plant controller 120 can be located within an off-site computing system such as a remote operations center or a cloud-based computing system. All such embodiments and distributed or centralized implementations should be considered within the scope of the present disclosure.

Still referring to FIG. 1, plant controller 120 is shown to include a historical database 130, predictor model 132, reward function evaluator 134, predictive controller 136, and predictor model trainer 140. In some embodiments, these components are implemented as functional modules of memory 128 or as data storage modules of memory 128. The functional modules of memory 128 (e.g., predictor model 132, reward function evaluator 134, predictive controller 136, and predictor model trainer 140) can be executed by processor 126 to cause processor 126 to perform the various functions described herein as functions of these components. The data storage modules of memory 128 (e.g., historical database 130) can be accessed by processor 126 to retrieve or obtain the data stored therein (e.g., system states).

Historical database 130 may store the historical and current values of the system states including values of the MVs, CVs, and DVs generated or observed during operation of plant controller 120 and plant 110. Historical database 130 may store a value for each of the MVs, CVs, and DVs, and/or other variables of interest (e.g., values of the reward function), values of variables measured by sensors 114, etc.) for each time step t or for each time period. The values stored in historical database 130 for past time steps form a set of historical data (i.e., historical states) which can be used to train predictor model 132. The values of the system states for current time steps can similarly be stored in historical database 130 and/or can be provided as direct inputs to predictor model 132 and/or predictive controller 136 during online operation of system 100 to monitor and control plant 110.

Predictor model 132 may be a neural network model, parametric model, state-space model, or any other type of predictive model configured to predict the values of the CVs at the next time step based on the current system state and a set of proposed MVs. Various embodiments of these and other types of predictive models which can be used as predictor model 132 are described in detail in U.S. patent application Ser. No. 17/831,227 filed Jun. 2, 2022 (“the '227 application), the entire disclosure of which is incorporated by reference herein. For example, predictor model 132 may be the same as or similar to the predictive model shown in FIG. 5 of the '227 application or any of the predictor neural networks shown in FIG. 7, 9, 11, 13, or 17 of the '227 application. It is contemplated that the systems and methods described throughout the present application can be used in combination with any of the embodiments described in detail in the '227 application. During online operation of plant controller 120, predictor model 132 may receive the current system state as an input from historical database 130, plant 110, or other components of system 100 and may receive proposed MVs from predictive controller 136. Predictor model 132 may output predicted values of the CVs which are predicted to result from the proposed MVs and the current system state.

Reward function evaluator 134 may receive the values of the CVs predicted by predictor model 132 and may use the predicted values of the CVs to evaluate the reward function J. The reward function/quantifies the performance of plant 110 as a function of the CVs (and in some cases other variables in addition to the CVs) and may define one or more objectives which predictive controller 136 seeks to minimize or maximize. Reward function evaluator 134 can use the values of the CVs at one or more time steps to evaluate the reward function J. In some embodiments, the value of the reward function J at a given time t is based on the values of the CVs at that same time t (e.g., Jₜ=ƒ(c_{1,t}, c_{2,t}, . . . , c_{n,t}), where n is the total number of CVs included in the reward function/and the variables c_{1,t}, c_{2,t}, . . . , c_{n,t} are the values of the CVs at time t. In other embodiments, the value of the reward function/may be based on the values of the CVs over a predetermined time period including multiple time steps t

$$( e . g . , J = {\sum }_{{t}^{′} = t}^{t + k} f ( {c}_{1 , {t}^{′}} , {c}_{2 , {t}^{′}} , … , {c}_{n , {t}^{′}} ) ) ,$$

where k is the total number of time steps t included in the time period over which the reward function/is evaluated. In some embodiments, the values of one or more of the MVs and/or DVs at one or more time steps can be included in the reward function J in addition to the values of the CVs. Reward function evaluator 134 may obtain values of the CVs, MVs, and/or DVs for each time step in the reward function J and use the values of the CVs, MVs, and/or DVs to calculate the value of the reward function J.

Predictive controller 136 may receive the system states as feedback from plant 110 and may generate the MVs provided as input to plant 110. Predictive controller 136 may use predictor model 132 and reward function evaluator 134 to generate a set of MVs that optimize the reward function J. For example, predictive controller 136 may use predictor model 132 to predict the values of the CVs that would result from a given trajectory of the MVs over a given time period (e.g., a timeseries of the MVs for each time step within the time period), shown in FIG. 1 as “proposed MVs.” The predicted values of the CVs can be provided as an input to reward function evaluator 134, which uses the predicted values of the CVs to calculate the value of the reward function/expected to result from the proposed MVs. Predictive controller 136 may adjust the set of proposed MVs (e.g., using an iterative optimization process) until the values of the CVs and the resulting value of the reward function/have been sufficiently optimized and may provide the resulting set of MVs as outputs to plant 110. Plant 110 may receive the MVs from predictive controller 136 and use the MVs to operate equipment 112.

In some embodiments, plant controller 120 is configured to predict or forecast values of the DVs over a future time period for use in predictor model 132 and/or by predictive controller 136. In some embodiments, one or more of the DVs represents a measurable disturbance (e.g., outside air temperature, input oil quality, etc.) which can be measured by sensors 114 and provided to plant controller 120 as an input from plant 110. Other DVs may represent unmeasurable disturbances which cannot be directly observed by sensors 114 but can be predicted by plant controller 120. Plant controller 120 can use any of a variety of predictive models to predict values of the DVs for each time step and can provide the values of the DVs as inputs to predictor model 132.

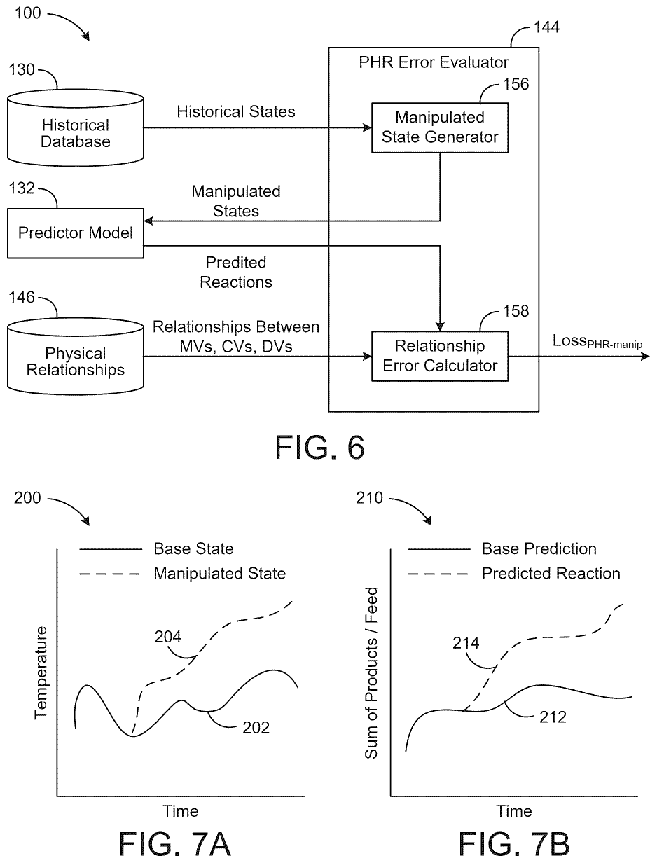

Plant controller 120 can execute any of a variety of control schemes that use predictor model 132 and/or predictive controller 136 for online control of plant 110. One example of such a control scheme is the model predictive control (MPC) scheme described in U.S. patent application Ser. No. 17/831,227 filed Jun. 2, 2022 (“the '227 application”), the entire disclosure of which is incorporated by reference herein. See FIGS. 5-6 of the '227 application and the description thereof for a detailed example of a MPC scheme which can be used by plant controller 120 in some embodiments. However, it should be understood that plant controller 120 can use any of a variety of control schemes in various other embodiments. For example, plant controller 120 can use a neural network control scheme such as any of the neural network embodiments described in the '227 application. See FIGS. 7-20 of the '227 application and the description thereof for detailed examples of various neural network control schemes which can be used by controller 120.

Some of the neural network control schemes which can be used by plant controller 120 can generally be referred to as deep learning process control (DLPC) schemes. Some DLPC schemes may use a predictor online such as the MPC scheme discussed above, whereas other DLPC schemes may use a predictor offline for training a controller neural network. For embodiments in which plant controller 120 uses a predictor offline to train a controller neural network, the training of the controller neural network may be performed using historical data where the disturbance values are known. Accordingly, the trained controller neural network in a DLPC scheme may have learned to account for future disturbance changes and thus may effectively include a disturbance forecaster within. It should be understood that plant controller 120 can use a control scheme with an online predictor, a control scheme with an offline predictor, or any other control scheme in various embodiments and that all such embodiments are within the scope of the present disclosure. Predictor model 132 can be used as either an online or offline predictor in various embodiments. Predictor model 132 can be trained prior to use by predictor model trainer 140.

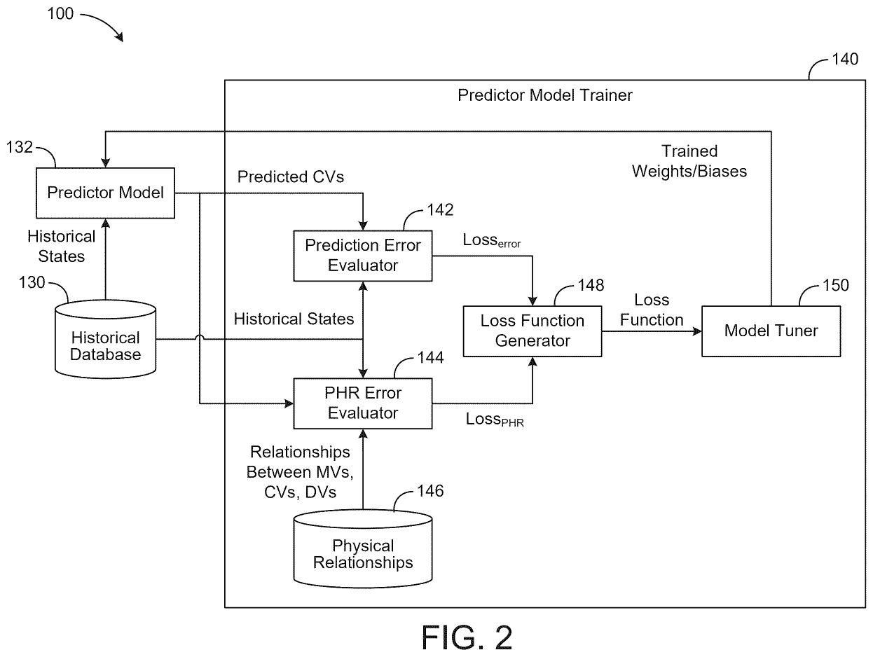

Predictor model trainer 140 may receive (e.g., obtain, gather, collect, etc.) the historical states from historical database 130 and may use the historical states to train predictor model 132. The model training processes used by predictor model trainer 140 are described in greater detail with reference to FIGS. 2-12. In some embodiments, the model training processes performed by predictor model trainer 140 occur offline, separate from the online operation of plant controller 120 (e.g., predictor model trainer 140 may be implemented as a separate component rather than being part of plant controller 120). In other embodiments, predictor model trainer 140 may be integrated with or otherwise combined with plant controller 120 (e.g., predictor model trainer 140 may be a component of plant controller 120) and the functions performed by predictor model trainer 140 may be performed by plant controller 120. Once the model training processes are completed, predictor model trainer 140 can provide the trained predictor model 132 to plant controller 120 for use during online operation. Providing the trained predictor model 132 may include providing a set of trained weights (e.g., model parameters, weights between neurons, etc.) which configure predictor model 132 for online operation.

In various embodiments, predictor model 132 and predictive controller 136 can be used to perform online control of plant 110 as described above or can be used to predict the performance of plant 110 without requiring online control. For example, in an embodiment that does not require online control, predictor model 132 can still be trained as described throughout the present disclosure and used to predict values of the CVs that will result from a proposed set of MVs. The predicted values of the CVs can be provided as inputs to reward function evaluator 134 to calculate the value of the reward function J and the proposed MVs can be adjusted by predictive controller 136 until the value of the reward function J is sufficiently optimized as described above. However, the resulting values of the MVs need not be provided to plant 110 and used to operate equipment 112. In this scenario, plant controller 120 may operate as a predictor without requiring closed loop control or online control of plant 110. Alternatively or additionally, the values of the MVs generated by plant controller 120 can be presented to a user (e.g., as recommendations) and may cause the user to take action to adjust equipment 112 of plant 110 without requiring automatic operation of equipment 112. In various embodiments, predictive controller 136 can control the operation of plant 110 either directly by automatically operating equipment 112 or indirectly by providing recommendations to a user responsible for operating equipment 112.

### Predictor Model Training

Referring now to FIG. 2, a block diagram illustrating predictor model trainer 140 in greater detail is shown, according to an exemplary embodiment. Predictor model trainer 140 can be configured to train predictor model 132 through iterative episodes drawn from historical data to predict the values of the CVs at the next time step. For embodiments in which predictor model 132 is implemented as a neural network, training predictor model 132 may include training the weights and/or biases between neurons or layers of the neural network. In such embodiments, predictor model trainer 140 may be referred to as a neural network model trainer. Predictor model trainer 140 may receive the historical states from historical database 130 and output trained weights and/or biases to predictor model 132.

Predictor model trainer 140 is shown to include prediction error evaluator 142, physical relationship (PHR) error evaluator 144, a database of physical relationships 146, a loss function generator 148, and a model tuner 150. These components of predictor model trainer 140 may cooperate to generate and evaluate a loss function that quantifies the error between the ground truth and the predictions generated by predictor model 132. In this context, the ground truth may include the historical values of the system states (i.e., the historical states shown in FIG. 2) stored in historical database 130 and the physical relationships 146 between MVs, CVs, and DVs. These two sources of ground truth may be consistent with each other or at least partially inconsistent to the extent that the historical states do not accurately reflect the physical relationships 146 (e.g., due to measurement errors or lack of sufficient generality in the historical state data). Accordingly, the loss function may include two terms as shown in the following equation:

$$Loss = {Loss}_{error} + λ {Loss}_{PHR}$$

where Loss is the overall value of the loss function, Lossₑᵣᵣₒᵣ is the loss based on the error in the predicted values of the CVs generated by predictor model 132 relative to the historical values of the CVs (e.g., in historical database 130), Loss_{PHR} is the loss based on the error in the predicted values of the CVs generated by predictor model 132 relative to expected values of the CVs based on physical relationships 146, and λ is a weight (λ>0) used to assign a relative importance to Loss_{PHR} relative to Lossₑᵣᵣₒᵣ. The model training process performed by predictor model trainer 140 may seek to reduce or minimize the overall value of the loss function Loss.

Prediction error evaluator 142 may be configured to generate and calculate the prediction error loss term Lossₑᵣᵣₒᵣ. Prediction error evaluator 142 is shown receiving the predicted CVs from predictor model 132 and historical states from historical database 130. As noted above, the historical states may include the historical values of the MVs, CVs, and/or DVs at each of a plurality of historical time steps or during historical time windows (referred to herein as “episodes”). The values of the CVs in historical database 130 may be treated as the “actual” values of the CVs by prediction error evaluator 142 for purposes of evaluating the prediction error. The predicted values of the CVs provided as inputs to prediction error evaluator 142 may be the corresponding values of the CVs predicted by predictor model 132 for the same historical states. For example, in some embodiments, the historical values of the MVs, DVs, and/or CVs from historical database 130 for one or more historical time steps are provided as inputs to predictor model 132 and used to predict the resulting values of the CVs at the next time step.

Prediction error evaluator 142 may generate the prediction error loss term Lossₑᵣᵣₒᵣ using any of a variety of error calculation techniques such as mean squared error (MSE), mean absolute error (MAE), root mean squared error (RMSE), or any other error calculation technique. For example, if MSE is used, prediction error evaluator 142 can calculate Lossₑᵣᵣₒᵣ as follows:

$${Loss}_{error} = \frac{1}{n} {\sum }_{i = 1}^{n} {( {CV}_{i} - )}^{2}$$

where CVᵢ is the actual value of the ith CV at a given time (e.g., as indicated by the historical states), [symbol] is the predicted value of that same CV at the same time as predicted by predictor model 132, and n is the total number of samples of the CVs for which MSE is calculated. As another example, if MAE is used instead of MSE, prediction error evaluator 142 can calculate Lossₑᵣᵣₒᵣ as follows:

$${Loss}_{error} = \frac{1}{n} {\sum }_{i = 1}^{n} \vert {CV}_{i} - \vert$$

where the absolute value of the error is used instead of the square of the error. These and/or other error calculation techniques can be used in various embodiments.

In some embodiments, prediction error evaluator 142 applies weights to one or more of the CVs when calculating Lossₑᵣᵣₒᵣ as shown in the following equations, which correspond to the MSE and MAE embodiments described above:

$${Loss}_{error} = \frac{1}{n} {\sum }_{i = 1}^{n} {w}_{i} \vert {CV}_{i} - \vert$$

$${Loss}_{error} = \frac{1}{n} {\sum }_{i = 1}^{n} {w}_{i} \vert {CV}_{i} - \vert$$

where wᵢ is the weight applied to the ith CV. In some embodiments, the weights indicate a relative importance of each CV in the calculation of Lossₑᵣᵣₒᵣ and can be defined or set by a user. In some embodiments, the weights are normalization factors that compensate for the relative scales or magnitudes of each CV. For example, the value of wᵢ may be inversely proportional to the value of CVᵢ (e.g., wᵢ=1/CVᵢ, wᵢ ∝1/CVᵢ) to ensure that that the CVs with relatively larger magnitudes or scales do not disproportionately skew the calculation of Lossₑᵣᵣₒᵣ. In some embodiments, the weights effectively normalize the contributions of each CV to the overall value of Lossₑᵣᵣₒᵣ (e.g., convert the errors into percentage errors or other normalized errors) such that each CV has equal ability to affect the value of Lossₑᵣᵣₒᵣ.

In some embodiments, prediction error evaluator 142 calculates Lossₑᵣᵣₒᵣ based on the actual and predicted values of the CVs over a time period as shown in the following equations, which correspond to the MSE and MAE embodiments described above:

$${Loss}_{error} = \frac{1}{n * h} {\sum }_{t = 1}^{h} {\sum }_{i = 1}^{n} {( {CV}_{it} - )}^{2}$$

$${Loss}_{error} = \frac{1}{n * h} {\sum }_{t = 1}^{h} {\sum }_{i = 1}^{n} {\vert {CV}_{it} - \vert}^{2}$$

where h is the length of the time horizon over which Lossₑᵣᵣₒᵣ is calculated (i.e., the number of time steps t in the time horizon), CVᵢₜ is the actual value of the ith CV at the tth time step, [symbol] is the predicted value of the ith CV at the tth time step, and the remaining variables are the same as described above.

In some embodiments, prediction error evaluator 142 can calculate Lossₑᵣᵣₒᵣ using both the weights wᵢ and the time periods as shown in the following two equations, which correspond to the MSE and MAE embodiments described above:

$${Loss}_{error} = \frac{1}{n * h} {\sum }_{t = 1}^{h} {\sum }_{i = 1}^{n} {( {CV}_{it} - )}^{2}$$

$${Loss}_{error} = \frac{1}{n * h} {\sum }_{t = 1}^{h} {\sum }_{i = 1}^{n} {\vert {CV}_{it} - \vert}^{2}$$

to ensure the value of Lossₑᵣᵣₒᵣ is both based on the normalized contributions of each CV and calculated based on the predicted and actual values of the CVs over a time period. In various embodiments, the same weights wᵢ can be used for all of the time step-specific values of the corresponding CVs (e.g., the same weight wᵢ can be applied to each value of CVᵢ₁, . . . , CVᵢₕ for all time steps 1 . . . h) or different weights can be used for each time step. For example, the weight wᵢ in the equations above can be replaced with a time step-specific weight wᵢₜ which applies to the ith CV at the tth time step, to allow the weights to vary across the time steps.

PHR error evaluator 144 may be configured to generate and calculate the physical relationships error loss term Loss_{PHR}. PHR error evaluator 144 is shown receiving the predicted CVs from predictor model 132, the physical relationships 146, and historical states from historical database 130. As noted above, the historical states may include the historical values of the MVs, CVs, and/or DVs at each of a plurality of historical time steps or during historical time windows. The predicted values of the CVs provided as inputs to PHR error evaluator 144 may be the corresponding values of the CVs predicted by predictor model 132 for the same historical states. In some embodiments, the historical values of the MVs, DVs, and/or CVs from historical database 130 for one or more historical time steps are provided as inputs to predictor model 132 and used to predict the resulting values of the CVs at the next time step.

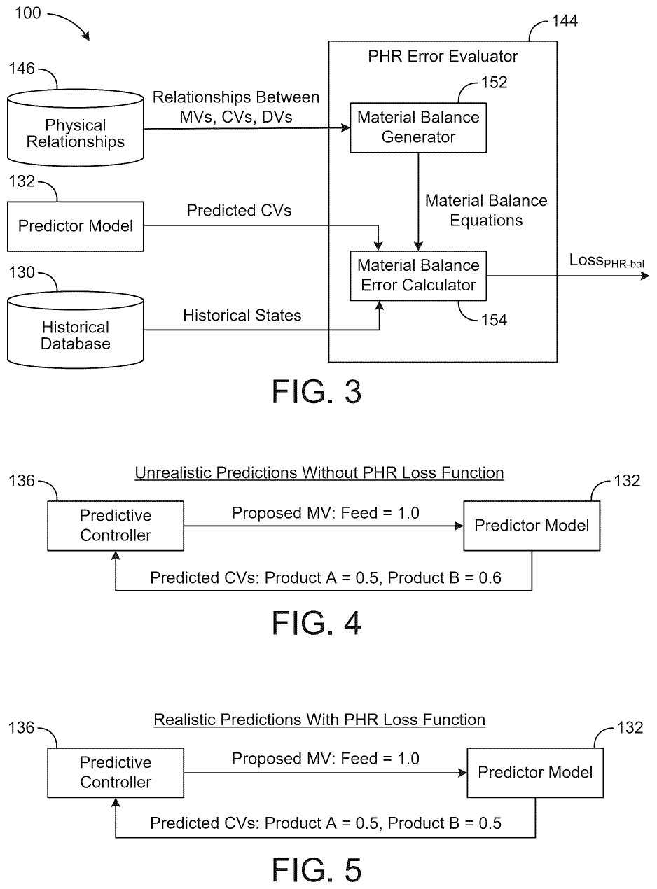

The physical relationships 146 may indicate the expected relationships between various MVs, CVs, and/or DVs. Some physical relationships 146 may be based on physical principles such as conservation of mass or energy, whereas other physical relationships 146 may be based on expected correlations such as whether a given CV is positively or negatively correlated with a given MV or DV. For example, if a given MV is the mass flow rate of an input oil feed into a reactor, physical relationships 146 may require the mass flow rates of the oil products generated as outputs of the reactor to have the same cumulative mass flow rate as the input oil feed due to the conservation of mass principle. As another example, if a given MV (e.g., reactor temperature) is known to be positively correlated with a given CV (e.g., volume of oil product produced), physical relationships 146 may require the value of the CV to increase if the value of the MV is increased. Several additional examples of physical relationships 146 and how they can be used by PHR error evaluator 144 to calculate Loss_{PHR} are described in greater detail with reference to FIGS. 3-11B.

In some embodiments, physical relationships 146 are based on first principles. First principles are calculations (e.g., equations, relationships, predictions, etc.) that are built on a fundamental understanding of the underlying phenomena (e.g., physio-chemical phenomena) that govern the relationships between the MVs, CVs, and DVs. These calculations can include reactor kinetics, internal and external mass or heat transfer, material balances (e.g., mass balances, volume balances, energy balances, etc.), or any other type of relationship based on physical principles. For systems where first principles are known for process units of plant 110 (e.g., equipment 112 which receive MVs as inputs and provide CVs as outputs), the physical relationships error loss term Loss_{PHR} can be used to require predictor model 132 to follow the known equations. Including this term in the overall loss function Loss assists predictor model 132 in accurately modeling real-world problems. Advantageously, by accurately predicting the process dynamics of plant 110 while enforcing physical relationships 146 based on first principles, predictor model 132 learns to better understand the real-time impacts of reactions, mass/heat transfer, and kinetics across different process units of plant 110. This leads to improved controller optimization of predictive controller 136 throughout any process units of plant 110 with known first principles.

In some embodiments, PHR error evaluator 144 considers only a single physical relationship 146 and may calculate a single PHR error loss term Loss_{PHR}. In other embodiments, PHR error evaluator 144 considers multiple physical relationships 146 and calculates multiple PHR error loss terms (e.g., Loss_{PHR,1}, Loss_{PHR,2}, Loss_{PHR,3}, etc.). Each of the multiple PHR error loss terms may correspond to a particular physical relationship 146 between the MVs, CVs, and DVs and may indicate the error between the values of the CVs predicted by predictor model 132 and the expected values of the CVs according to the corresponding physical relationship 146. In some embodiments, both the predicted CVs generated by predictor model 132 and the expected CVs according to the physical relationships 146 may be based on a time window of values of the MVs, CVs, and DVs leading up to the time at which the values of the CVs are predicted by predictor model 132 and calculated according to the physical relationships 146. In this way, both predictor model 132 and PHR error evaluator 144 can consider time-dependent relationships between the MVs, CVs, and DVs that depend on multiple time steps rather than making an instantaneous prediction based on only the most recent time step.

Loss function generator 148 may receive the prediction error loss term Lossₑᵣᵣₒᵣ from prediction error evaluator 142 and the physical relationships error loss term Loss_{PHR} from PHR error evaluator 144. Loss function generator 148 may combine the two error loss terms to calculate the overall loss function Loss as follows:

$$Loss = {Loss}_{error} + λ {Loss}_{PHR}$$

For embodiments in which multiple physical relationships 146 are considered, loss function generator 148 may calculate the overall loss function Loss as follows:

$$Loss = {Loss}_{error} + {λ}_{1} {Loss}_{PHR , 1} + {λ}_{2} {Loss}_{PHR , 2} + {λ}_{3} {Loss}_{PHR , 3} + ⋯ + {λ}_{n} {Loss}_{PHR , n}$$

where n is the total number of physical relationships 146 considered and λ₁ . . . λₙ are weights (λ₁ . . . λₙ>0) assigned to their respective PHR error loss terms Loss_{PHR,1} . . . Loss_{PHR,n} to indicate the relative importance of each PHR error loss term in the overall loss function.

In some embodiments, loss function generator 148 calculates the overall loss function Loss as a linear summation of the various loss terms as shown in the previous two equations. In other embodiments, loss function generator 148 can calculate the overall loss function Loss using any other mathematical formula or function of the various loss terms (e.g., multiplication, division, exponential functions, logarithmic functions, etc.). In general, loss function generator 148 can calculate the overall loss function Loss using the following functions:

$$Loss = f ( {Loss}_{error} , {Loss}_{PHR} )$$

$$Loss = f ( {Loss}_{error} , {Loss}_{PHR , 1} , {Loss}_{PHR , 2} , {Loss}_{PHR , 3} , ⋯ , {Loss}_{PHR , n} )$$

which correspond to the two embodiments discussed above (i.e., a single physical relationship is considered and multiple physical relationships are considered, respectively), where ƒ( ) is any function of the various loss terms.

Advantageously, loss function generator 148 can augment the overall loss function with these penalty terms (i.e., Loss_{PHR}, Loss_{PHR,1}, Loss_{PHR,2}, etc.) instead of imposing hard constraints on the operation of predictor model 132. The advantage of this penalty-based approach is that it allows flexibility in the values of the CVs predicted by predictor model 132 because measured variables typically do not obey physical laws perfectly. This may be due to time delays, measurement errors, or physical phenomena not accounted for by predictor model 132 (e.g., leakage of mass, volume swell/loss, etc.). The penalties imposed on the loss function by the PHR error terms allow predictor model trainer 140 to generate a suitable predictor model 132 that satisfies the physical relationships 146 as closely as possible (or as closely as desired, which can be adjusted by setting the values of the weights λ₁ . . . λₙ) while still allowing the predicted values of the CVs to deviate from their expected values (i.e., the values expected based purely on physical relationships 146) to allow for sources of measurement error or process error.

Loss function generator 148 may provide the loss function Loss or value of the loss function to model tuner 150 for use in tuning predictor model 132. Model tuner 150 may use any of a variety of model tuning techniques to adjust the weights of predictor model 132 in an effort to minimize the value of the overall loss function Loss. In some embodiments, model tuner 150 uses an iterative tuning process that includes adjusting the weights of predictor model 132, using predictor model 132 to generate the predicted values of the CVs, and evaluating the loss function Loss for each set of values of the weights. Model tuner 150 can continue adjusting the model weights using an iterative optimization technique (e.g., gradient descent) until the resulting value of the loss function Loss is sufficiently small or has been minimized according to predetermined optimization criteria (e.g., convergence criteria). Several examples of PHR error terms which can be used by predictor model trainer 140 are described in detail below.

### Physical Relationships Based on Material Balance

Referring now to FIG. 3, an embodiment is shown in which PHR error evaluator 144 uses physical relationships 146 based on conservation principles such as material balances (e.g., mass balances, volume balances, energy balances, etc.) to generate the PHR error loss term Loss_{PHR} or terms Loss_{PHR,1}, . . . , Loss_{PHR,n} in the overall loss function Loss. PHR error evaluator 144 is shown to include a material balance generator 152 and a material balance error calculator 154.

Material balance generator 152 can be configured to generate one or more material balance equations based on material balance relationships between the MVs, CVs, and DVs. These relationships can be defined by or derived from physical relationships 146. As one example, physical relationships 146 may specify that the sum of the MVs representing the mass flow rates of one or more input oil feeds into a process unit (i.e., into equipment 112 of plant 110) must be equal the sum of the CVs representing the mass flow rates of the output products exiting that same process unit to satisfy a conservation of mass principle. That is, the masses of the input oil feeds flowing into the process unit must be equal to the masses of the output products exiting the process unit. Such a material balance equation can be defined as follows:

$${\sum }_{i = 1}^{n} {MassFeed}_{i} = {\sum }_{j = 1}^{m} {MassProduct}_{j}$$

where MassFeedᵢ is the mass feed rate (e.g., kg/s) of the ith feed into the process unit, MassProductⱼ is the mass output rate (e.g., kg/s) of the jth product exiting the process unit, n is the total number of feeds into the process unit, and m is the total number of products exiting the process unit. The values of MassFeedᵢ may be MVs generated by predictive controller 136, whereas the values of MassProductⱼ may be CVs predicted by predictor model 132.

As another example, physical relationships 146 may specify that the sum of the MVs representing the volumes of the one or more input oil feeds into the process unit multiplied by a volume swell/loss factor must be equal to the sum of the CVs representing the volume flow rates of the output products exiting that same process unit to satisfy a conservation of volume principle. Such a material balance equation can be defined as follows:

$${\sum }_{i = 1}^{n} {VolumeFeed}_{i} * {η}_{unit} = {\sum }_{j = 1}^{m} {VolumeProduct}_{j}$$

where VolumeFeedᵢ is the volumetric feed rate (e.g., m³/s) of the ith feed into the process unit, VolumeProductⱼ is the volumetric output rate (e.g., m³/s) of the jth product exiting the process unit, ηᵤₙᵢₜ is the volume swell within the process unit, n is the total number of feeds into the process unit, and m is the total number of products exiting the process unit. The volume swell ηᵤₙᵢₜ may be equal to 1.0 on units that do not have any volume change, greater than 1.0 on units that have volume swell (i.e., the volume of the products is greater than the volume of the feeds), and less than 1.0 on units that have volume loss (i.e., the volume of the products is less than the volume of the feeds). The values of VolumeFeedᵢ may be MVs generated by predictive controller 136, whereas the values of VolumeProductⱼ may be CVs predicted by predictor model 132. Material balance generator 152 can provide the material balance equations to material balance error calculator 154.

Material balance error calculator 154 is shown receiving the material balance equations from material balance generator 152, the predicted CVs from predictor model 132, and the historical states from historical database 130. Material balance error calculator 154 can use these inputs to calculate the values of the PHR error loss term Loss_{PHR}, which is shown in FIG. 3 as Loss_{PHR-bal} to denote the PHR error loss based on material balance relationships specifically. Material balance error calculator 154 can use the predicted CVs from predictor model 132 as the values of any variables in the material balance equations that represent predicted CVs (e.g., MassProductⱼ, VolumeProductⱼ, etc.) and can use the historical states from historical database 130 as the values of any variables in the material balance equations that represent MVs, DVs, or historical values of CVs (e.g., MassFeedᵢ, VolumeFeedᵢ, ηᵤₙᵢₜ, etc.).

Material balance error calculator 154 can calculate the material balance PHR error loss term Loss_{PHR-bal} using any of a variety of techniques that quantify the error or difference between the left side and right side of each material balance equation, as both sides of the equation should theoretically be equal according to the material balance relationships. For example, for the material balance equations provided above for mass and volume balances, material balance error calculator 154 can calculate the corresponding material balance PHR error loss terms Loss_{PHR-bal} as follows:

$${Loss}_{PHR - b a l} = \vert {\sum }_{i = 1}^{n} {MassFeed}_{i} - {\sum }_{j = 1}^{m} {MassProduct}_{j} \vert and$$

$${Loss}_{PHR - bal} = \vert {\sum }_{i = 1}^{n} {VolumeFeed}_{i} * {η}_{unit} - {\sum }_{j = 1}^{m} {VolumeProduct}_{j} \vert$$

where the brackets | | represent the absolute value of the expression contained therein. In some embodiments, other types of error calculations can be used in place of absolute value such as squaring the expressions contained within the absolute value brackets instead of calculating their absolute values. Material balance error calculator 154 can calculate the material balance PHR error loss term Loss_{PHR-bal} for a single material balance equation or a plurality of material balance equations, each corresponding to a different PHR error loss term (e.g., Loss_{PHR-bal,1} . . . Loss_{PHR-bal,n}) in the overall loss function.

In some embodiments, material balance error calculator 154 calculates the material balance PHR error loss term Loss_{PHR-bal} using the rectified linear unit (relu) or rectifier activation function. The relu function can be expressed as a piecewise-defined function as follows:

$$relu ( x ) = \{ \begin{matrix}x & if x > 0 \\ 0 & if x \leq 0\end{matrix}$$

such that the output of the relu function is equal to its input x (or monotonically increases as a function of its input x) when x is positive, but equal to zero when x is less than or equal to zero. Material balance error calculator 154 can calculate the value of Loss_{PHR-bal} using the relu function by defining the input x in a manner that causes x to be positive when the material balance error (i.e., the output of the absolute value functions above) exceeds a threshold Y as shown in the following equations:

$${Loss}_{PHR - b a l} = relu ( \vert {\sum }_{i = 1}^{n} {MassFeed}_{i} - {\sum }_{j = 1}^{m} {MassProduct}_{j} \vert - Y ) and$$

$${Loss}_{PHR - bal} = relu ( \vert {\sum }_{i = 1}^{n} {VolumeFeed}_{i} * {η}_{unit} - {\sum }_{j = 1}^{m} {VolumeProduct}_{j} \vert - Y )$$

This allows material balance error calculator 154 to penalize material balance errors that exceed the value of the threshold Y while imposing no penalty if the material balance error is less than or equal to the value of the threshold Y. Alternatively, the signs on both the threshold Y and the material balance error can be reversed (e.g., Loss_{PHR-bal}=relu (Y−|error|)) to penalize values of the error that are less than the threshold Y while imposing no penalty for values of the error that exceed the threshold Y.

In some embodiments, material balance error calculator 154 performs the material balance error calculation for each time step within a given time period. For example, if predictor model 132 generates predicted values of the CVs over a time period which includes multiple time steps (i.e., a value of each CV at each time step), material balance error calculator 154 can calculate the material balance PHR error loss term Loss_{PHR-bal} or terms Loss_{PHR-bal,1} . . . Loss_{PHR-bal,n} for each time step within the time period. In some embodiments, material balance error calculator 154 calculates the material balance PHR error loss term(s) for the entire time period by summing or otherwise aggregating the values of the PHR error loss term(s) at each time step.

For example, material balance error calculator 154 can construct a vector where each element of the vector includes the value of Loss_{PHR-bal} for a particular time step k of the time period and calculate an L1 norm or L2 norm of the vector to generate an aggregated value of Loss_{PHR-bal} over the time period. This can be expressed mathematically as:

$${Loss}_{PHR - b a l} = {( {\vert \vert {\sum }_{i = 1}^{n} {MassFeed}_{i} - {\sum }_{j = 1}^{m} {MassProduct}_{j} \vert \vert}_{p} )}^{p} or$$

$${Loss}_{PHR - bal} = {( {\vert \vert {\sum }_{i = 1}^{n} {VolumeFeed}_{i} * {η}_{unit} - {\sum }_{j = 1}^{m} {VolumeProduct}_{j} \vert \vert}_{p} )}^{p}$$

where the notation (∥X∥ₚ)^{p} denotes the L1 norm (p=1) or the L2 norm (p=2) of the vector X and each element of the vector X includes the value of

$${\sum }_{i = 1}^{n} {MassFeed}_{i} - {\sum }_{j = 1}^{m} {MassProduct}_{j} or$$

$${\sum }_{i = 1}^{n} {VolumeFeed}_{i} * {η}_{unit} - {\sum }_{j = 1}^{m} {VolumeProduct}_{j}$$

at a particular time step k=1 . . . q of the time period.

For example, the vector X can be defined as follows for the mass balance equation:

$$X = [ \begin{matrix}\begin{matrix}( {\sum }_{i = 1}^{n} & {MassFeed}_{i} - \begin{matrix}{\sum }_{j = 1}^{m} & {{MassProduct}_{j} )}_{1}\end{matrix}\end{matrix} \\ ⋮ \\ \begin{matrix}( {\sum }_{i = 1}^{n} & {MassFeed}_{i} - \begin{matrix}{\sum }_{j = 1}^{m} & {{MassProduct}_{j} )}_{q}\end{matrix}\end{matrix}\end{matrix} ]$$

and as follows for the volume balance equation:

$$X = [ \begin{matrix}\begin{matrix}( {\sum }_{i = 1}^{n} & {VolumeFeed}_{i} * {η}_{unit} - \begin{matrix}{\sum }_{j = 1}^{m} & {{VolumeProduct}_{j} )}_{1}\end{matrix}\end{matrix} \\ ⋮ \\ \begin{matrix}( {\sum }_{i = 1}^{n} & {VolumeFeed}_{i} * {η}_{unit} - \begin{matrix}{\sum }_{j = 1}^{m} & {{VolumeProduct}_{j} )}_{q}\end{matrix}\end{matrix}\end{matrix} ]$$

where q is the total number of time steps within the time period.

Advantageously, material balance error calculator 154 can use these and other types of material balance equations to calculate the value(s) of Loss_{PHR-bal}. When incorporated into the overall loss function Loss, the values of Loss_{PHR-bal} penalize predicted values of the CVs that violate the material balance equations by increasing the value of the overall loss function based on the magnitude or degree of the violation (i.e., the amount by which the predicted CVs violate the physical relationships 146). In this way, predictor model trainer 140 can ensure that predictor model 132 will not learn incorrect relationships that create or destroy mass or volume. While mass and volume balance equations are provided as examples for ease of explanation, it is contemplated that PHR error evaluator 144 can use any type of balance equation (e.g., energy, mass, volume, momentum, etc.) that represents a conservation principle in various embodiments.

Referring now to FIGS. 4-5, block diagrams illustrating the improvements to the predictions generated by predictor model 132 when trained using the PHR error loss term Loss_{PHR-bal} are shown, according to exemplary embodiments. FIG. 4 illustrates a scenario where predictor model 132 is trained using only the historical states from historical database 130 without accounting for the physical relationships 146 and without using the PHR error loss term Loss_{PHR-bal}. In this scenario, predictive controller 136 provides predictor model 132 with a proposed value of a MV representing the total volume or mass of an input feed into a reactor (i.e., Feed=1.0). Predictor model 132 generates predicted CVs indicating that the total volume or mass of two products (i.e., Product A and Product B) produced from this input feed will be Product A=0.5 and Product B=0.6 respectively. Assuming no volume swell (ηᵤₙᵢₜ=1), these predictions violate the material balance principles of conservation of mass and conservation of volume because the total mass/volume of the products exceeds the total mass/volume of the input feed.

FIG. 5 illustrates a scenario where predictor model 132 is trained using both the historical states from historical database 130 and the physical relationships 146 to add penalties Loss_{PHR-bal} to overall loss function during model training. In this scenario, predictive controller 136 provides predictor model 132 with the same proposed value of the MV representing the total volume or mass of an input feed into a reactor (i.e., Feed=1.0). However, because predictor model 132 has been trained using mass and volume material balance equations based on physical relationships 146, predictor model 132 generates predicted CVs indicating that the total volume or mass of Product A and Product B will be Product A=0.5 and Product B=0.5 respectively. Assuming no volume swell (ηᵤₙᵢₜ=1), these predictions satisfy the material balance principles of conservation of mass and conservation of volume because the total mass/volume of the products is equal to the total mass/volume of the input feed.

### Physical Relationships Based on Manipulated States

Referring now to FIG. 6, an embodiment is shown in which PHR error evaluator 144 uses manipulated states and physical relationships 146 representing positive or negative correlations between MVs, DVs, and CVs to generate the PHR error loss term Loss_{PHR} or terms Loss_{PHR,1}, . . . ,Loss_{PHR,n} in the overall loss function Loss. These types of physical relationships 146 may indicate whether increasing or decreasing a given MV or DV is expected to result in a corresponding increase or decrease in a predicted CV. PHR error evaluator 144 is shown to include a manipulated state generator 156 and a relationship error calculator 158.

Manipulated state generator 156 can be configured to generate one or more manipulated states based on the historical states stored in historical database 130. Manipulated states may include modified values of MVs, DVs, or CVs that deviate from the actual values of the MVs, DVs, or CVs stored in historical database 130, referred to herein as “base states.” In some embodiments, manipulated state generator 156 obtains the base states from historical database 130 and modifies them (e.g., by adding or subtracting a predetermined value or applying a step function) to generate the manipulated states. For example, given a base state S obtained from historical database 130, manipulated state generator 156 can generate a set of manipulated states

$${S}_{1}^{′} , … , {S}_{k}^{′}$$

by modifying the base state S (e.g., by adding or subtracting various predetermined values to the base state S, multiplying the base state S by fractions, etc.). Each of the manipulated states

$${S}_{1}^{′} , … , {S}_{k}^{′}$$

may be a different manipulation to the same base state S, for example, by adding or subtracting different values, multiplying by different fractions, etc.

Manipulated state generator 156 can use predictor model 132 to generate predicted reactions to the manipulated states

$${S}_{1}^{′} , … , {S}_{k}^{′} .$$

The predicted reactions may include predicted values of the CVs predicted by predictor model 132 to result from each of the base state S and the manipulated states

$${S}_{1}^{′} , … , {S}_{k}^{′} .$$

The predicted reactions to the base state S are denoted by the base prediction P, whereas the predicted reactions to each of the manipulated states

$${S}_{1}^{′} , … , {S}_{k}^{′}$$

are denoted by the predictions

$${P}_{1}^{′} , … , {P}_{k}^{′}$$

respectively, in some embodiments, each of the predictions

$${P}_{1}^{′} , … , {P}_{k}^{′}$$

corresponds to one of the manipulated states

$${S}_{1}^{′} , … , {S}_{k}^{′}$$

and indicates how the base prediction P (i.e., CVs predicted by predictor model 132) is predicted to react or change if the base state S is changed to the corresponding manipulated state. For example, the first prediction

$${P}_{1}^{′}$$

may indicate the predicted reaction or change in the base prediction P if the base state S is changed to first manipulated state

$${S}_{1}^{′} ,$$

whereas the kth prediction

$${P}_{k}^{′}$$

may indicate the predicted reaction or change in the base prediction P if the base state S is changed to kth manipulated state

$${S}_{k}^{′} .$$

In various embodiments, the manipulate states

$${s}_{1}^{l} , … , {s}_{k}^{l}$$

and the predictions

$${P}_{1}^{l} , … , {P}_{k}^{l}$$

indicate different alternative values of the MVs and CVs respectively at the same time or at different times over a given time period.

Referring now to FIGS. 7A-7B two graphs 200 and 210 are shown illustrating an example of the manipulated states

$${S}_{1}^{′} , … , {S}_{k}^{′}$$

and the predictions

$${P}_{1}^{′} , … , {P}_{k}^{′} .$$

As shown in FIG. 7A, the base state S is the value of a MV representing the temperature of a process unit in which an input (e.g., an input oil feed) is converted into one or more products (e.g., output oil products). Line 202 in graph 200 represents the base state S at each time including actual historical values of the temperature obtained from historical database 130. Line 204 in graph 200 represents a manipulated state

$${S}_{1}^{′}$$

generated by manipulated state generator 156 by increasing the values of the temperature MV relative to the base state S. The values of line 204 represent a trajectory of the manipulated state

$${S}_{1}^{′}$$

over time.

As shown in FIG. 7B, the base prediction P is the value of a CV representing the ratio between the sum of products produced by the process unit and the feed of the input into the process unit (i.e., products/feed). Both the sum of products and the input feed can be quantified as volume or mass flow rates in various embodiments. Line 212 in graph 210 represents the base prediction P corresponding to the base state S at each time in the time period. Line 214 in graph 210 represents a prediction

$${P}_{1}^{′}$$

(i.e., a predicted reaction) generated by predictor model 132 based on the manipulated state

$${S}_{1}^{′}$$

(e.g., a predicted value of the CV). The values of line 214 represent a trajectory of the prediction

$${P}_{1}^{′}$$

over time. While only one base state S, manipulated state

$${S}_{1}^{′} ,$$

base prediction P, and predicted reaction

$${P}_{1}^{′}$$

are shown in FIGS. 7A-7B, it is contemplated that manipulated state generator 156 can generate any number of manipulated states for any number of MVs and/or DVs and use predictor model 132 to generate any number of predicted reactions.

Referring again to FIG. 6, relationship error calculator 158 is shown receiving the predicted reactions from predictor model 132 and the relationships between MVs, CVs, and DVs from physical relationships 146. In this context, the predicted reactions may include the base state S and manipulated states

$${S}_{1}^{′} , … , {S}_{k}^{′}$$

as well as the base prediction P predicted to result from the base state S and the predictions

$${P}_{1}^{′} , … , {P}_{k}^{′}$$

predicted to result from each of the manipulated states

$${S}_{1}^{′} , … , {S}_{k}^{′} .$$

Relationship error calculator 158 can use these inputs to calculate the values of the PHR error loss term Loss_{PHR}, which is shown in FIG. 6 as Loss_{PHR-manip} to denote the PHR error loss based on manipulated states and predicted reactions specifically.

In some embodiments, relationship error calculator 158 calculates the PHR error loss term Loss_{PHR-manip} as a function of one or more of the above inputs as follows:

$${Loss}_{PHR - manip} = f ( S , {S}_{1}^{′} , … , {S}_{k}^{′} ; P , {P}_{1}^{′} , … , {P}_{k}^{′} )$$

where the function ƒ( ) is based on knowledge of the physical relationships 146 indicating how the predictions

$${P}_{1}^{′} , … , {P}_{k}^{′}$$

should react to the manipulated states

$${S}_{1}^{′} , … , {S}_{k}^{′}$$

according to first principles. For example, if the physical relationships 146 specify that a given MV and CV should be positively correlated (i.e., increasing the MV should cause the CV to increase, whereas decreasing the MV should cause the CV to decrease), the function ƒ( ) used by relationship error calculator 158 may cause the value of Loss_{PHR-manip} to increase when the MV and CV are negatively correlated. Conversely, if the physical relationships 146 specify that a given MV and CV should be negatively correlated (i.e., increasing the MV should cause the CV to decrease, whereas decreasing the MV should cause the CV to increase), the function ƒ( ) used by relationship error calculator 158 may cause the value of Loss_{PHR-manip} to increase when the MV and CV are positively correlated.

One type of function ƒ( ) which can be used to define Loss_{PHR-manip} in this manner is the relu(x) function described above. Relationship error calculator 158 can calculate the value of Loss_{PHR-manip} using the relu function by defining the input x in a manner that causes the input x to be positive when the predicted reactions

$${P}_{1}^{′} , … , {P}_{k}^{′}$$

predicted by predictor model 132 to the manipulated states

$${S}_{1}^{′} , … , {S}_{k}^{′}$$

are inconsistent with the physical relationships 146 indicating what the relationships between the MVs, CVs, and DVs should be according to first principles.

For example, consider a scenario in which the physical relationships 146 indicate a given MV and CV are positively correlated and manipulated state generator 156 generates a manipulated state

$${S}_{1}^{′}$$

for the MV which exceeds the base state S for the MV

$${P}_{1}^{′}$$

In this scenario, the predicted value of the prediction

$$( i . e . , {S}_{1}^{′} > S ) .$$

should exceed the value of the base prediction P

$$( i . e . , {P}_{1}^{′} > P )$$

in order to satisfy the physical relationship 146. Accordingly, relationship error calculator 158 can calculate the value of Loss_{PHR-manip} as follows:

$${Loss}_{PHR - manip} = relu ( P - {P}_{1}^{′} )$$

such that the input to the relu function is negative and

$${Loss}_{PHR - manip} = 0 when {P}_{1}^{′} > P$$

and the physical relationship 146 is satisfied, but becomes increasingly positive when

$$P > {P}_{1}^{′}$$

and the physical relationship 146 is not satisfied. Thus, the penalty to the overall loss function Loss imposed by the term Loss_{PHR-manip} becomes increasingly higher as the prediction

$${P}_{1}^{′}$$

becomes increasingly inconsistent with the physical relationship 146.

In some embodiments, the inputs to the relu function can be reversed to

$${P}_{1}^{′} - P$$

(i.e., multiplied by −1) if the scenario is modified to one in which either the physical relationship 146 indicates the MV and CV are negatively correlated or manipulated state generator 156 generates a manipulated state

$${S}_{1}^{′}$$

for the MV which is less than the base state S for the MV

$$( i . e . , {S}_{1}^{′} < S ) .$$

To more generally account for these scenarios, the above equation for Loss_{PHR-manip} can be generalized as follows:

$${Loss}_{PHR - manip} = relu ( C * M * ( P - {P}_{1}^{′} ) )$$

where C is a binary variable C={−1,1} which is set to C=1 if the physical relationships 146 indicate the MV and CV are positively correlated and set to C=−1 if the physical relationships 146 indicate the MV and CV are negatively correlated, and M is a binary variable M={−1,1} which is set to M=1 if the manipulated state exceeds the base state

$$( i . e . , {S}_{1}^{′} < S )$$

and set to M=−1 if the manipulated state is less than the base state

$$( i . e . , {S}_{1}^{′} < S ) .$$

Accordingly, the penalty imposed by the PHR loss term Loss_{PHR-manip} is only applied (i.e., only has a non-zero value) if the change in the prediction

$${P}_{1}^{′}$$

relative to the base prediction P is inconsistent with the change that should occur based on first principles, as indicated by the physical relationships 146.

In some embodiments, the inputs to the relu function further include an offset X as shown in the following equation:

$${Loss}_{PHR - manip} = relu ( C * M * ( P - {P}_{1}^{′} ) + X )$$

where X indicates the expected change in the prediction

$${P}_{1}^{′}$$

relative to the base prediction P (i.e., the difference

$${P}_{1}^{′} - P )$$

which should occur according to the physical relationships 146. The offset X can be used to penalize changes in the prediction

$${P}_{1}^{′}$$

relative to the base prediction P that are greater than or less than the value of the offset X, rather than simply requiring the difference

$${P}_{1}^{′} - P$$

to have the same sign as the correlation indicated by the physical relationships 146 to avoid incurring the penalty. For example, the above equation can be used (assuming C=1 and M=1) if it is desirable to penalize changes in the prediction

$${P}_{1}^{′}$$

relative to the base prediction P that are less than the offset X. Accordingly, the input to the relu function will be positive and thus a non-zero penalty Loss_{PHR-manip} will be applied if the difference

$${P}_{1}^{′} - P$$

is less than the value of the offset X. Alternatively, if it is desirable to penalize changes in the prediction

$${P}_{1}^{′}$$

relative to the base prediction P that exceed the expected change X according to the physical relationships 146, the inputs to the relu function can be multiplied by −1 as shown in the following equation:

$${LOSS}_{PHR - manip} = relu ( - C * M * ( P - {P}_{1}^{′} ) - X )$$

Accordingly, the input to the relu function will be positive and thus a non-zero penalty Loss_{PHR-manip} will be applied if the difference

$${P}_{1}^{′} - P$$

is greater than the value of the offset X (again assuming C=1 and M=1).

Applying this functionality to the particular scenario illustrated in graphs 200 and 210 shown in FIGS. 7A-7B, manipulated state generator 156 is shown generating manipulated states

$${S}_{1}^{′}$$

for the temperature MV (line 204) which exceed the base state S for the temperature MV (line 202). The prediction

$${P}_{1}^{′}$$

generated by predictor model 132 (line 214) is also shown exceeding the base prediction P (line 212). The physical relationships 146 in this scenario indicates that the temperature MV and the sum of products/feed CV should be positively correlated, but does not require any particular positive correlation to avoid incurring the penalty (i.e., no offset X). Accordingly, relationship error calculator 158 can calculate the value of Loss_{PHR-manip} as follows:

$${LOSS}_{PHR - manip} = relu ( C * M * ( P - {P}_{1}^{′} ) + X ) where$$

$$C = 1 , M = 1 , P - {P}_{1}^{′}$$

is negative, and X=0. This results in the input to the relu function as a whole being negative and thus Loss_{PHR-manip}=0. Conversely, if any of (i) the physical relationships 146 had indicated that the temperature MV and the sum of products/feed CV should be negatively correlated (ii) the manipulated state

$${S}_{1}^{′}$$

had been less than the base S, or (iii) the prediction

$${P}_{1}^{′}$$

generated by predictor model 132 had been less than the base prediction P, then the corresponding term within the relu function would have its sign reversed.

Advantageously, relationship error calculator 158 can use these and other types of physical relationships 146, manipulated states, and predicted reactions to calculate the value(s) of Loss_{PHR-manip}. When incorporated into the overall loss function Loss, the values of Loss_{PHR-manip} penalize predicted reactions to manipulated states are inconsistent with the physical relationships 146 between the MVs and CVs. Further, the magnitude of the inconsistency (i.e., the magnitude of

$$P - {P}_{1}^{′} )$$

causes the penalty Loss_{PHR-manip} to increase proportionally to the magnitude of

$$P - {P}_{1}^{′}$$

when the value of the relu function is positive to impose harsher penalties on larger inconsistencies. In this way, predictor model trainer 140 can ensure that predictor model 132 will not learn incorrect relationships that cause the MVs and CVs to move in physically implausible directions that contradict the physical relationships 146.

### Physical Relationships Based on Gradients

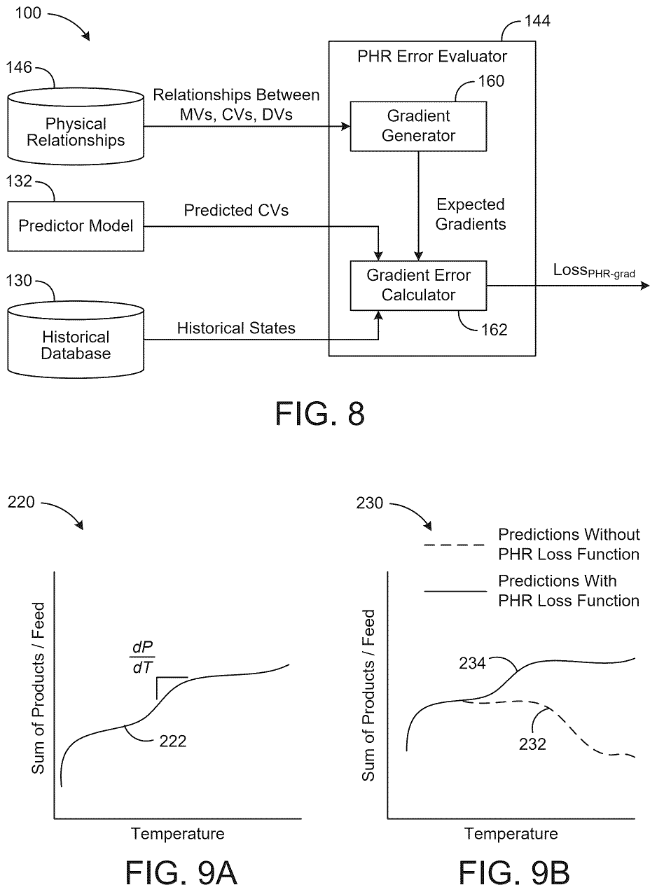

Referring now to FIG. 8, an embodiment is shown in which PHR error evaluator 144 uses expected gradients between MVs, DVs, and CVs to generate the PHR error loss term Loss_{PHR} or terms Loss_{PHR,1}, . . . , Loss_{PHR,n} in the overall loss function Loss. For embodiments in which predictor model 132 is a neural network, PHR error evaluator 144 can readily calculate the gradients of the predictions generated as output(s) of the neural network with respect to the input(s) to the neural network

$$( e . g . , \frac{d ( predictions )}{d ( inputs )} ) .$$

In this context, the term “predicted gradients” refers to the gradients calculated based on the predicted CVs generated by predictor model 132 in combination with the historical states, whereas the term “expected gradients” refers to the gradients expected based purely on the physical relationships 146.

PHR error evaluator 144 is shown to include a gradient generator 160 and a gradient error calculator 162. Gradient generator 160 is shown receiving the physical relationships 146 indicating the relationships between the MVs, CVs, and DVs which should occur according to first principles. The physical relationships 146 may indicate that two or more variables are positively correlated, negatively correlated, or have any other relationship. In some embodiments, the physical relationships 146 include analytical functions that relate two or more variables. For example, the physical relationships 146 may include functions such as:

$${CV}_{1} = 2 {MV}_{1} + 3 {CV}_{2} + 6$$

$${CV}_{2} = {DV}_{1} - 8 {MV}_{3}$$

which indicate how the CVs, MVs, and DVs are related according to first principles. In some embodiments, the physical relationships 146 directly indicate the expected gradients between variables or can be used to determine the expected gradients. The physical relationships 146 do not necessarily align with the calculated gradients between the variables based on the historical states, but rather are based on first principles that indicate how the MVs, CVs, and DVs should be related according to the physical phenomena that govern the controlled system or process.

Gradient generator 160 can analyze the physical relationships 146 and generate expected gradients between variables based on the physical relationships 146. For example, for the exemplary physical relationships 146 indicated above, gradient generator 160 can generate the following expected gradients:

$$\frac{d ( {CV}_{1} )}{d ( {MV}_{1} )} = 2 , \frac{d ( {CV}_{1} )}{d ( {CV}_{2} )} = 3 , \frac{d ( {CV}_{2} )}{d ( {DV}_{1} )} = 1 , \frac{d ( {CV}_{2} )}{d ( {MV}_{3} )} = - 8$$

where each expected gradient is the gradient (e.g., partial derivative) of a particular CV with respect to a particular MV or DV upon which that CV depends. Gradient generator 160 can use any of a variety of analytical or numerical techniques to calculate the expected gradients based on the physical relationships 146. While these examples use simple linear functions that relate the CVs, MVs, and DVs, it is contemplated that any type of linear or nonlinear function can be used to express the physical relationships 146 and derive the expected gradients in various embodiments. Gradients can be defined for each CV with respect to each MV, DV, and/or CV on which the CV depends.

Gradient error calculator 162 is shown receiving the expected gradients from gradient generator, the predicted CVs from predictor model 132, and the historical states from historical database. Gradient error calculator 162 can use these inputs to calculate the values of the PHR error loss term Loss_{PHR}, which is shown in FIG. 8 as Loss_{PHR-grad} to denote the PHR error loss based on expected gradients specifically. In some embodiments, gradient error calculator 162 uses the expected gradients to generate an equation or function for calculating the PHR error loss term Loss_{PHR-grad}. The form of the function may be based on the expected gradients, whereas the inputs to the function may be based on the predicted CVs from predictor model 132 and the historical states from historical database 130. For example, the predicted CVs and the historical states can be used to calculate predicted gradients between the predicted CVs and the MVs and/or DVs in the historical state data, which can be compared against the expected gradients to determine whether the predicted gradients are consistent with the expected gradients.

In some embodiments, gradient error calculator 162 generates the PHR error loss term Loss_{PHR-grad} based on expected gradients in a similar manner as the PHR error loss term Loss_{PHR-manip} is generated based on manipulated states as discussed above with reference to FIGS. 6-7B. For example, gradient error calculator 162 can generate the PHR error loss term Loss_{PHR-grad} using a function ƒ( ) based on knowledge of the expected gradients based on the physical relationships 146. If the gradient of a particular CV with respect to a particular MV is expected to be positive based on the expected gradients (i.e., increasing the MV should cause the CV to increase, whereas decreasing the MV should cause the CV to decrease), the function ƒ( ) used by gradient error calculator 162 may cause the value of Loss_{PHR-grad} to increase if the predicted gradient is negative. Conversely, if the gradient of a particular CV with respect to a particular MV is expected to be negative (i.e., increasing the MV should cause the CV to decrease, whereas decreasing the MV should cause the CV to increase), the function ƒ( ) used by gradient error calculator 162 may cause the value of Loss_{PHR-grad} to increase if the predicted gradient is positive.

In some embodiments, gradient error calculator 162 uses the relu function to calculate the gradient-based PHR error loss term Loss_{PHR-grad} in a manner similar to the manipulated state-based PHR error loss term Loss_{PHR-manip}. For example, consider a scenario in which the expected gradients based on the physical relationships 146 indicate the gradient of a given CV (i.e., CV₁) with respect to a given MV

$$( i . e . , {MV}_{1} )$$

should be positive

$$( i . e . , \frac{d ( {CV}_{1} )}{d ( {MV}_{1} )} > 0 ) .$$

In this scenario, gradient error calculator 162 can calculate the value of Loss_{PHR-grad} as follows:

$${Loss}_{PHR - grad} = relu ( - \frac{d ( {CV}_{1} )}{d ( {MV}_{1} )} )$$

where the values of MV₁ are given by the historical states and the values of CV₁ are generated by predictor model 132 and used to calculate the gradient

$$\frac{d ( {CV}_{1} )}{d ( {MV}_{1} )} .$$

Accordingly, the input to the relu function is negative and thus Loss_{PHR-grad}=0 when the predicted gradient

$$\frac{d ( {CV}_{1} )}{d ( {MV}_{1} )}$$

is positive and thus consistent with the expected gradient. However, if the predicted gradient

$$\frac{d ( {CV}_{1} )}{d ( {MV}_{1} )}$$

is negative, the input to the relu function would be positive and thus Loss_{PHR-grad} is proportional to the magnitude of the predicted gradient

$$\frac{d ( {CV}_{1} )}{d ( {MV}_{1} )} .$$

In some embodiments, the inputs to the relu function can be multiplied by −1 if the scenario is modified to one in which the expected gradient based on the physical relationships 146 is negative. To more generally account for both positive and negative expected gradients, the above equation for Loss_{PHR-grad} can be generalized as follows:

$${Loss}_{PHR - grad} = relu ( - C * \frac{d ( {CV}_{1} )}{d ( {MV}_{1} )} )$$

where C is a binary variable C={−1,1} which is set to C=1 if the sign of the expected gradient is positive and set to C=−1 if the sign of the expected gradient is negative. In this way, the function for Loss_{PHR-grad} penalizes negative predicted gradients if the expected gradient is positive and penalizes positive predicted gradients if the expected gradient is negative.

In some embodiments, gradient error calculator 162 uses both the magnitudes and signs of the expected gradients to formulate the equation for Loss_{PHR-grad}. For example, if the expected gradient between a given CV CV₁ and a given MV MV₁ is −3, gradient error calculator 162 can calculate Loss_{PHR-grad} as follows:

$${Loss}_{PHR - grad} = relu ( \frac{d ( {CV}_{1} )}{d ( {MV}_{1} )} + 3 )$$

such that the value of the input to the relu function will be positive and thus a non-zero penalty Loss_{PHR-grad} will be applied if the predicted gradient

$$\frac{d ( {CV}_{1} )}{d ( {MV}_{1} )}$$

based on the predicted values of the CVs is greater than −3. Alternatively, if it is desired to penalize the predicted gradient

$$\frac{d ( {CV}_{1} )}{d ( {MV}_{1} )}$$

being less than the expected gradient, gradient error calculator 162 can calculate Loss_{PHR-grad} as follows:

$${Loss}_{PHR - grad} = relu ( - \frac{d ( {CV}_{1} )}{d ( {MV}_{1} )} - 3 )$$

such that the value of the input to the relu function will be positive and thus a non-zero penalty Loss_{PHR-grad} will be applied if the predicted gradient

$$\frac{d ( {CV}_{1} )}{d ( {MV}_{1} )}$$

based on the predicted values of the CVs is less than −3. While these specific equations are provided as examples of how Loss_{PHR-grad} can be calculated for an expected gradient of −3, it is contemplated that they can be generalized by using variables to represent the sign of the expected gradient and/or the magnitude of the expected gradient as discussed above.

Referring now to FIGS. 9A-9B, two graphs 220 and 230 are shown illustrating an example of the expected gradients based on physical relationships 146 (graph 220) and the impact of the PHR error loss term Loss_{PHR-grad} on the predictions made by predictor model 132 (graph 230). As shown in FIG. 9A, line 222 represents a physical relationship 146 between the MV “temperature” on the horizontal axis of graph 220 and the CV “sum of products/feed” on the vertical axis of graph 220. The slope

$$\frac{dP}{dT}$$

of line 222 represents the expected gradient of this CV with respect to this MV. The physical relationship 146 represented by line 222 can be stored as an analytical function (e.g., a linear, quadratic, cubic, or higher order function) or as a numerical relationship. In some embodiments, the gradient

$$\frac{dP}{dT}$$

is not constant at all points along line 222 but rather varies based on the particular location at which the gradient

$$\frac{dP}{dT}$$

is taken. In some embodiments, gradient generator 160 uses an input value of the MV or the CV in the physical relationship 146 to determine the location along line 222 at which the gradient

$$\frac{dP}{dT}$$

is to be obtained when generating the expected gradient based on this physical relationship 146.

FIG. 9B illustrates the improvement in the predictions generated by predictor model 132 when the PHR error loss term Loss_{PHR-grad} is included in the calculation of the overall loss function Loss. Line 232 in graph 230 represents the predicted values of the CV when predictor model 132 is trained without accounting for the PHR error loss term Loss_{PHR-grad}. Notably, the predicted values of the CV represented by line 232 differs significantly from the values of the CV expected based on the physical relationship 146 (i.e., the values predicted by line 222 in graph 220). Line 234 in graph 230 represents the predicted values of the CV when predictor model 132 is trained while accounting for the PHR error loss term Loss_{PHR-grad}. The predicted values of the CV represented by line 234 are much closer to the values of the CV expected based on the physical relationship 146 (i.e., the values predicted by line 222 in graph 220). Thus, it is evident that accounting for the PHR error loss term Loss_{PHR-grad} when training predictor model 132 significantly improves the accuracy of predictor model 132 once trained.

### Physical Relationships Based on Empirical Data

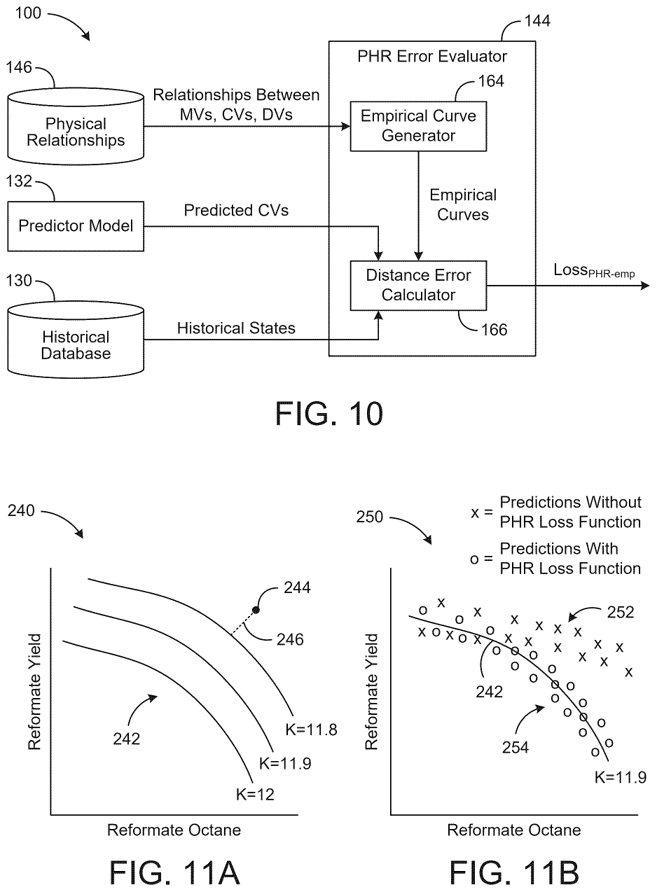

Referring now to FIG. 10, an embodiment is shown in which PHR error evaluator 144 uses empirical relationships between MVs, DVs, and CVs to generate the PHR error loss term Loss_{PHR} or terms Loss_{PHR,1}, . . . , Loss_{PHR,n} in the overall loss function Loss. Empirical relationships are correlations that have been found and supported by experiments and observations. In equipment 112 of plant 110 (e.g., process units), empirical relationships can be used to understand process dynamics and unit performance over time where first principles may not be well understood. Accordingly, empirical relationships can be used to represent first principles (e.g., as a substitute for first principles) in scenarios where the actual physical relationship between variables is unknown but can be approximated from empirical data. Various types of empirical relationships (e.g., solubility curves, coking rates in equipment, catalyst deactivation, corrosion rates, tray efficiency, etc.) can be used to improve the performance of predictor model 132. In some embodiments, empirical relationships are generated and stored as a type of physical relationships 146 between MVs, CVs, and DVs.

PHR error evaluator 144 can use empirical relationships in largely the same manner as other types of physical relationships 146. For example, PHR error evaluator 144 can use empirical relationships to determine expected values of one or more CVs based on the current and/or historical states of the controlled system or process (e.g., plant 110). The expected values of the CVs based on the empirical relationships can be compared against the predicted values of the CVs generated by predictor model 132 to quantify the PHR error loss term. PHR error evaluator 144 is shown to include an empirical curve generator 164 and a distance error calculator 166.

Empirical curve generator 164 is shown receiving the physical relationships 146 indicating empirical relationships between the MVs, CVs, and DVs. These types of physical relationships 146 can be generated based on experimental data, observations of prior system operation, and/or the historical states stored in historical database 130. In some embodiments, the empirical relationships are indicated by sets of historical data stored in historical database 130. For example, if the historical states indicate that a given MV and CV are correlated, an empirical relationship can be generated to represent the correlation and stored as a type of physical relationships 146. The physical relationships 146 may indicate that two or more variables are positively correlated, negatively correlated, or have any other relationship. In some embodiments, the physical relationships 146 provided as an input to empirical curve generator 164 include a collection of empirical data (e.g., values of MVs, CVs, and DVs) for various time steps.

Empirical curve generator 164 can use the physical relationships 146 to generate empirical curves representing the relationships between the MVs, CVs, and DVs. In some embodiments, empirical curve generator 164 generates the empirical curves by performing a regression process (e.g., fitting a curve) or other type of numerical analysis to derive a relationship or function that relates two or more variables represented in the historical state data. The empirical curves may express the value of one or more CVs as functions of one or more MVs, DVs, or other CVs. For example, the empirical curves may include functions such as:

$${CV}_{1} = 1 \text{.85} {MV}_{1} - 2 \text{.45} {MV}_{2} + 1 \text{.89}$$

$${CV}_{2} = 0 \text{.45} {DV}_{1} - 8 \text{.55} {MV}_{3} - 2.08$$

where CV₁, CV₂, MV₁, MV₂, and DV₁ are particular CVs, MVs, and DVs represented in the empirical data and the numbers are regression coefficients generated by performing a regression process on the empirical data. While these example functions are shown as linear functions for ease of explanation, it is contemplated that empirical curve generator 164 can fit any type of curve to the empirical data including quadratic, cubic, or higher order functions, or other types of nonlinear functions (e.g., logarithmic, inverse, exponential, sinusoidal, etc.), and can be configured to determine the most appropriate type of empirical curve to generate based on the characteristics of the empirical data (e.g., by evaluating which type of curve best fits the data). In various embodiments, the empirical curves can be 2-dimensional curves if the empirical relationship is between two variables or higher order curves (e.g., 3-dimensional surfaces in 3-dimensional space, N-dimensional curves or surfaces in N-dimensional space) depending on the number of variables related by the empirical curves.

Referring to FIG. 11A, a graph 240 illustrating an example of an empirical curve 242 which can be generated by empirical curve generator 164 is shown, according to an exemplary embodiment. Empirical curve 242 is an Octane-Yield curve representing an empirical relationship between reformate yield and reformate octane. In this example, both of the variables shown in graph 240 are CVs. However, it is contemplated that one or more of the variables in various empirical curves can be MVs, DVs, or other CVs in different empirical curves, depending on which sets of variables are used to generate the empirical curves. As shown in graph 240, the relationship between reformate yield and reformate octane is nonlinear and negative, such that reformate yield increases as reformate octane decreases, and vice versa. The different lines labeled K=12, K=11.9, and K=11.8 in graph 240 represent different Waston Characterization Factors (K). Empirical curve generator 164 can be configured to generate any type of number of empirical curves representing relationships between any set of variables in the historical state data.

Referring again to FIG. 10, distance error calculator 166 is shown receiving the empirical curves from empirical curve generator 164, the predicted CVs from predictor model 132, and the historical states from historical database 130. In this context, the predicted CVs from predictor model 132 may include predictions based purely on the historical states (e.g., current or historical values of the MVs, CVs, and DVs) without accounting for PHR error loss, before predictor model 132 is fully trained or tuned based on the physical relationships 146. Accordingly, the predicted CVs may deviate significantly from the expected values of the CVs based on the empirical curves and/or the physical relationships 146.

Distance error calculator 166 can be configured to generate a set of points based on the predicted CVs and the historical states. Each point may include two or more dimensions representing the predicted CVs and the historical states. The number of dimensions of each point may be equal to or based on the number of variables related by the corresponding empirical curve. For example, if a given empirical curve relates one CV and one MV, the number of dimensions of the points may be equal to two (i.e., one for the CV and one for the MV). The CV value(s) of each point may be provided by the predicted CVs from predictor model 132, whereas the other values of each point may be based on the historical state data. As one example, distance error calculator 166 can generate the following set of points for the Octane-Yield curve shown in FIG. 11A:

$$\{ ( {CV}_{1 , p 1} , {CV}_{2 , p 1} ) , ( {CV}_{1 , p 2} , {CV}_{2 , p 2} ) , ( {CV}_{1 , p 3} , {CV}_{2 , p 3} ) , … , ( {CV}_{1 , pn} , {CV}_{2 , p n} ) \}$$

where the first point (CV_{1,p1}, CV_{2,p1}) includes the first pair of predicted values of the first CV (i.e., reformate octane) and second CV (i.e., reformate yield), the second point (CV_{1,p2}, CV_{2,p2}) includes the second pair of predicted values of the first CV and second CV, and so on until reaching the nth point, (CV_{1,pn}, CV_{2,pn}) which includes the nth pair of predicted values of the first CV and second CV. An example of such a point is shown in FIG. 11A as point 244, where the x-coordinate of point 244 is the predicted value of the CV for reformate octane and the y-coordinate of point 244 is the predicted value of the CV for reformate yield, generated by predictor model 132.

Distance error calculator 166 can be configured to calculate the distance between each point based on the predicted CVs and the corresponding empirical curve generated by empirical curve generator 164. Distance error calculator 166 can use any of a variety of distance calculation techniques to calculate the distance between each point and the closest point on the empirical curve. For each point generated based on the predicted CVs, distance error calculator 166 can calculate the length of a line that extends perpendicularly from the empirical curve and ends at the point. The length of such a line represents the minimum distance between the point and the empirical curve. An example of such a line is shown in FIG. 11A as line 246, where the distance represented by line 246 is the shortest distance between point 244 and the empirical curve 242 for K=11.8. Although only one point 244 and line 246 are shown in FIG. 11A for ease of explanation, it is contemplated that distance error calculator 166 can generate any number of points (e.g., one point for each predicted value of the CVs) and any number of lines representing the shortest distances between the points and the corresponding empirical curve.

Distance error calculator 166 can use the calculated distances to calculate values of the PHR error loss term Loss_{PHR}, which is shown in FIG. 10 as Loss_{PHR-emp} to denote the PHR error loss based on empirical relationships specifically. For example, distance error calculator 166 can calculate Loss_{PHR-emp} as follows:

$${Loss}_{PHR - emp} = dist ( \{ {P}_{i , 1} , {P}_{i , 2} , {P}_{i , 3} , … , {P}_{i , n} \} , {f}_{EC , i} )$$

where the function dist is a distance calculation function, the set of points {P_{i,1}, P_{i,2}, P_{i,3}, . . . , P_{i,n}} includes the n points generated by distance error calculator 166 based on the predicted CVs for the ith empirical relationship, and ƒ_{EC,i} is the empirical curve generated by empirical curve generator 164 for the ith empirical relationship. In some embodiments, the distance calculation function dist aggregates (e.g., sums, averages, etc.) the minimum distances between each point in the set of points {P_{i,1}, P_{i,2}, P_{i,3}, . . . , P_{i,n}} and the empirical curve ƒ_{EC,i}.

In some embodiments, distance error calculator 166 calculates Loss_{PHR-emp} using the relu(x) function described above. For example, distance error calculator 166 can define the input x to the relu function in a manner that causes x to be positive when the output of the distance calculation function dist exceeds a threshold Z as shown in the following equation:

$${Loss}_{PHR - emp} = relu ( dist ( \{ {P}_{i , 1} , {P}_{i , 2} , {P}_{i , 3} , … , {P}_{i , n} \} , {f}_{EC , i} ) - Z )$$

This allows distance error calculator 166 to penalize values of the distance calculation function dist that exceed the value of the threshold Z while imposing no penalty if the value of the distance function dist is less than or equal to the value of the threshold Z. Alternatively, the signs on both the threshold Z and the distance calculation function dist can be reversed (e.g., Loss_{PHR-emp}=relu(Z−dist)) to penalize values of the distance calculation function dist that are less than the threshold Z while imposing no penalty for values of the distance calculation function dist that exceed the threshold Z.

In some embodiments, empirical curve generator 164 and distance error calculator 166 perform the steps described above for multiple different empirical relationships to generate an empirical curve ƒ_{EC,i} and a set of points {P_{i,1}, P_{i,2}, P_{i,3}, . . . , P_{i,n}} for each empirical relationship i=1 . . . m where m is the total number of empirical relationships. Distance error calculator 166 can calculate a value of Loss_{PHR-emp} for each of the m empirical relationships and aggregate the different values of Loss_{PHR-emp} (e.g., by summation, averaging, etc.) to calculate a value of Loss_{PHR-emp} to include in the overall loss function Loss. In other embodiments, distance error calculator 166 includes all of the calculated values of Loss_{PHR-emp} in the overall loss function and assigns each of them a corresponding weight λ₁ . . . λₘ as described above to assign a relative importance to each empirical relationship. For example, the overall loss function Loss can be formulated as follows:

$$Loss = {Loss}_{e rror} + … + {λ}_{1} {Loss}_{PHR - emp , 1} + {λ}_{2} {Loss}_{PHR - emp , 2} + … + {λ}_{m} {Loss}_{PHR - emp , m}$$

where each of the terms λ₁ Loss_{PHR-emp,1}, λ₂Loss_{PHR-emp,2}, . . . , λₘLoss_{PHR-emp,m} corresponds to a different PHR loss based on a different empirical relationship.

Referring now to FIG. 11B, a graph 250 illustrating the improvement provided by training predictor model 132 using empirical relationships is shown, according to an exemplary embodiment. Empirical curve 242 represents the empirical curve generated for the two CVs representing reformate octane and reformate yield, as shown in FIG. 11A. The set of points 252 labeled with x's represent the predictions of predictor model 132 when predictor model 132 is trained without accounting for the PHR error loss term Loss_{PHR-emp}. Notably, the predicted values of the CVs represented by points 252 differ significantly from the empirical curve 242. The set of points 254 labeled with o's represent the predictions of predictor model 132 when predictor model 132 is trained while accounting for the PHR error loss term Loss_{PHR-emp}. The predicted values of the CVs represented by points 254 are much closer to empirical curve 242 representing the empirical relationship. Thus, it is evident that accounting for the PHR error loss term Loss_{PHR-emp} when training predictor model 132 significantly improves the accuracy of predictor model 132 once trained.

Advantageously, using known or observed empirical relationships (e.g., the Octane-Yield curve in FIGS. 11A-11B) allows predictor model trainer 140 to train predictor model 132 in a manner that ensures the predictions generated by predictor model 132 respect (e.g., align with or are close to) the actual empirical relationships between variables. Another benefit of improved predictor model performance is realized if/when predictor model 132 is used to train predictive controller 136. If predictor model 132 fails to adhere to the established empirical correlation, predictive controller 136 will learn to optimize towards a level that cannot be attained in real-world scenarios.

### Physical Relationships Based on Gain Architecture

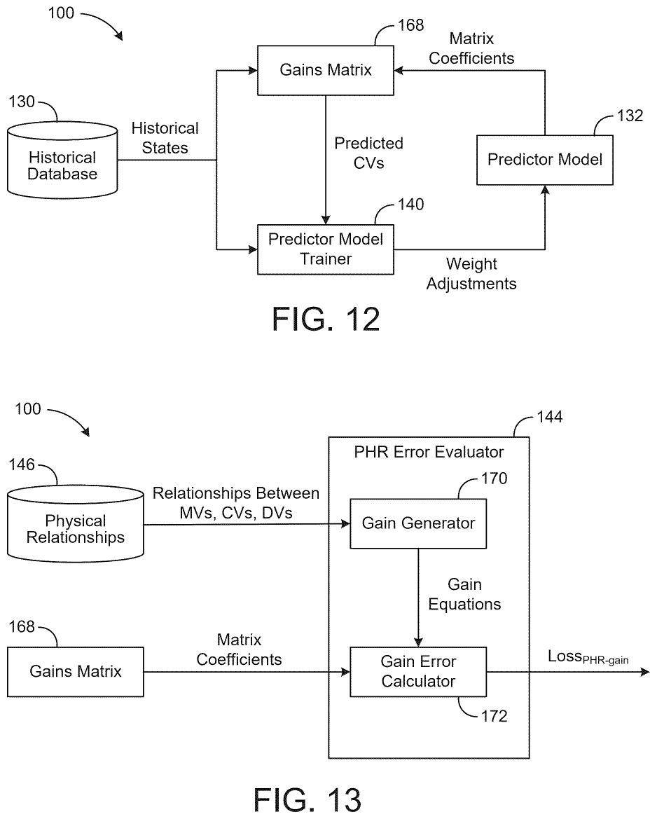

Referring now to FIGS. 12-13, an embodiment is shown in which PHR error evaluator 144 uses coefficients of a gains matrix 168 to generate the PHR error loss term Loss_{PHR} or terms Loss_{PHR,1}, . . . ,Loss_{PHR,n} in the overall loss function Loss. The coefficients or elements of gains matrix 168 (referred to herein as “matrix coefficients”) reflect the input/output relationships between the MVs, DVs, and CVs in plant 110. That is, the matrix coefficients indicate the gains that are applied to the inputs to plant 110 (e.g., MVs and DVs) when translating the inputs into the outputs of plant 110 (e.g., CVs). Accordingly, the values of the matrix coefficients have physical meaning and should respect the physical relationships 146 between the MVs, DVs, and CVs in plant 110.

In some embodiments, the behavior of plant 110 is nonlinear over the full range of operation of plant 110, but can be approximated as linear within a given time period or within various localized operating regions. Gains matrix 168 and the matrix coefficients contained therein may provide a localized linear approximation of plant behavior within the given time period or operating region. Accordingly, gains matrix 168 can be used to predict the values of the CVs that will result from a given set of inputs to plant 110 (e.g., MVs, DVs, etc.) when operating within the localized linear region using efficient linear techniques (e.g., linear state-space models, etc.). Several examples of how gains matrix 168 can be generated and used to predict the behavior of plant 110 are described in greater detail in U.S. Pat. No. 11,886,154 granted Jan. 30, 2024, the entire disclosure of which is incorporated by reference herein. A brief summary is provided in the following paragraphs.

Referring particularly to FIG. 12, predictor model trainer 140 is shown training predictor model 132 to generate the matrix coefficients of gains matrix 168. In some embodiments, gains matrix 168 includes a set of matrix coefficients which represent the dynamic response of plant 110 to a given plant state. Gains matrix 168 can be used to translate a given plant state (e.g., values of the MVs, DVs, and CVs for a given time period or episode) into corresponding values of the CVs predicted to result from that plant state. In some embodiments, gain matrix 168 represents a local linearization of the dynamic behavior of plant 110 localized to a particular operating region. For example, if the range of dynamic behavior of plant 110 is nonlinear over its entire range of operation, gains matrix 168 can be used to represent the dynamic behavior as approximately linear over a smaller range of operation in some scenarios. Additional details regarding gains matrix 168 and how such a gains matrix 168 can be generated and used by plant controller 120 are described in detail in U.S. patent application Ser. No. 17/831,227 filed Jun. 2, 2022, the entire disclosure of which is incorporated by reference herein.

Predictor model trainer 140 may receive a set of historical states from historical database 130 indicating the values of the MVs, DVs, and CVs for a given time period or episode of the historical state data. Predictor model trainer 140 can adjust the weights of predictor model 132 (e.g., weights of a predictor neural network) which causes predictor model 132 to produce adjusted matrix coefficients as an output. The matrix coefficients are used to populate gains matrix 168. Gains matrix 168 is then used to predict values of CVs that will result from the values of the MVs and/or DVs in the historical state data. Predictor model trainer 140 compares the predicted values of the CVs generated by gains matrix 168 against the actual values of the CVs in the historical state data from historical database 130 to determine an error in the predicted CVs relative to the actual CVs. Predictor model trainer 140 then adjusts the weights of predictor model 132 in a manner estimated to reduce the error. This process can be repeated iteratively by predictor model trainer 140 until the error is sufficiently minimized, at which point predictor model 132 is considered sufficiently trained.

Referring now to FIG. 13, PHR error evaluator 144 is shown using the physical relationships 146 between the MVs, CVs, and DVs and the matrix coefficients of gains matrix 168 to generate the PHR error loss term Loss_{PHR-gain}. PHR error evaluator 144 is shown to include a gain generator 170 which uses the physical relationships 146 to generate one or more gain equations. The gain equations may define the expected values of the matrix coefficients and/or expected relationships between the matrix coefficients based on the physical relationships 146. For example, consider a simple scenario in which plant 110 receives one input (i.e., an input oil feed) and produces two output products (i.e., product A and product B). The gains matrix 168 for this scenario can be expressed as:

$$[ \begin{matrix}Product A \\ Product B\end{matrix} ] = Feed [ \begin{matrix}MC ( Feed , Product A ) \\ MC ( Feed , Product B )\end{matrix} ]$$

where Feed is a MV or DV representing an attribute of the input oil feed (e.g., mass, volume, etc.), ProductA is a CV representing an attribute of the first output product (e.g., mass, volume, etc.), and ProductB is a CV representing an attribute of the second output product (e.g., mass, volume, etc.). The term MC (Feed, ProductA) represents the set of matrix coefficients of gains matrix 168 (i.e., the matrix on the right side of the equation) that are used when translating the value of the Feed variable into the value of the ProductA variable. Similarly, the term MC (Feed, ProductB) represents the set of matrix coefficients of gains matrix 168 that are used when translating the value of the Feed variable into the value of the ProductB variable.

Physical relationships 146 may specify that the mass or volume of the input oil feed consumed over a given time period should be equal to the combined mass or volume of the two output products produced over the same time period. Stated differently, physical relationships 146 may specify that the sum of the gains applied by gains matrix 168 when translating from the input oil feed into product A (i.e., MC (Feed, ProductA)) and the gains applied by gains matrix 168 when translating from the input oil feed into product B (i.e., MC (Feed, ProductB)) should be equal to 1. The gain equation for this scenario can be expressed as:

$${\sum }_{t = 1}^{h} ( MC ( Feed , ProductA ) + MC ( Feed , ProductB ) ) = 1$$

The gain equation sums the values of the matrix coefficients over time steps t=1 . . . h and sets the summation equal to 1. Accordingly, this gain equation specifies that sum of the matrix coefficients MC (Feed, ProductA)+MC (Feed, ProductB) is expected to be equal to 1 according to the physical relationships 146. Although the value of 1 is used in this example, it is contemplated that other values may be used to denote other types of physical relationships 146. For example, if the variables in the gain equation represent volumes and the process performed by plant 110 is expected to result in volume swell or volume loss when converting between inputs and outputs, the value of 1 may be replaced by a larger or smaller number to denote the expected amount of volume swell or volume loss respectively.

Gain error calculator 172 may receive the gain equations from gain generator 170 and the values of the matrix coefficients from gains matrix 168. Gain error calculator 172 can use these inputs to calculate the gain PHR error loss term Loss_{PHR-gain}. For example, for the exemplary scenario described above, gain error calculator 172 can calculate the gain PHR error loss term Loss_{PHR-gain} using the following equation:

$${Loss}_{PHR - gain} = \vert {\sum }_{t = 1}^{h} ( MC ( Feed , ProductA ) + MC ( Feed , ProductB ) ) - 1 \vert$$

where the summation calculates the sum of the matrix coefficients MC (Feed, ProductA)+MC (Feed, ProductB) over the time period t=1 . . . h and the other terms in the equation calculate the absolute value of the difference between this summation and 1. Accordingly, gain error calculator 172 can define the gain PHR error loss term Loss_{PHR-gain} as the absolute value of the difference between the summed matrix coefficients and 1 over the given time period. Again, this equation indicates that the summation is expected to equal 1 according to the physical relationships 146, but the value of 1 can be replaced with any other value if the physical relationships 146 indicate that the summation is expected to equal any other value.

In some embodiments, gain error calculator 172 uses the relu(x) function to calculate the gain PHR error loss term Loss_{PHR-gain} by defining the input x in a manner that causes x to be positive when the summation of the matrix coefficients exceeds a threshold W as shown in the following equation:

$${Loss}_{PHR - gain} = relu ( {\sum }_{C = 1}^{h} ( MC ( Feed , ProductA ) + MC ( Feed , ProductB ) ) - W )$$

This allows gain error calculator 172 to penalize matrix coefficients that sum to more than the value of the threshold W while imposing no penalty if the matrix coefficients sum to less than or equal to the value of the threshold W. Alternatively, the signs on both the threshold W and the matrix coefficients can be reversed

$$( e . g . , {Loss}_{PHR - gain} = relu ( W - {\sum }_{t = 1}^{h} ( … ) ) )$$

to penalize values of the matrix coefficients that sum to less than the threshold W while imposing no penalty for values of the matrix coefficients that sum to greater than or equal to the threshold W.

### Graphs Illustrating Improved Prediction and Optimization Spaces

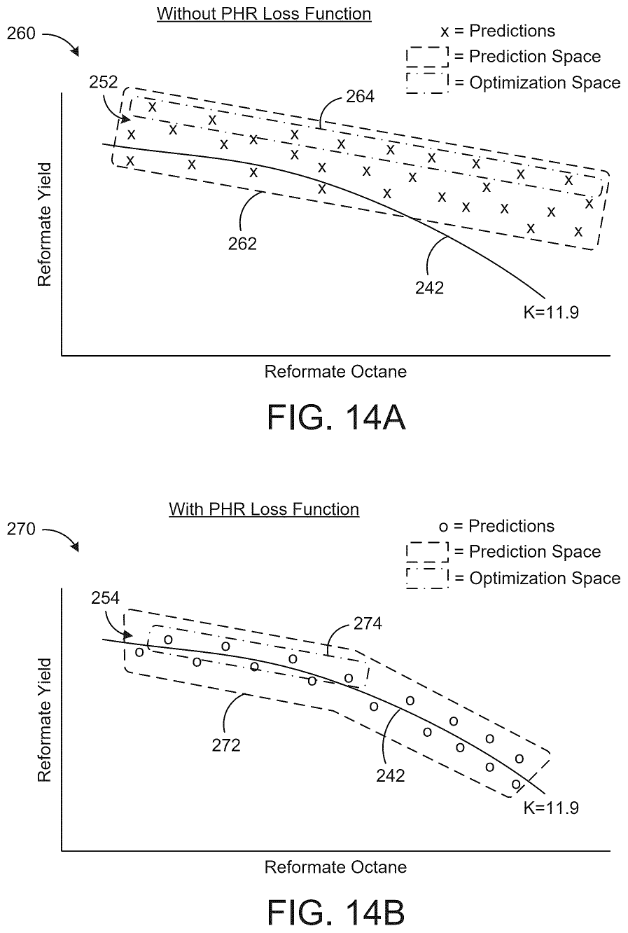

Referring now to FIGS. 14A-14B, graphs 260 and 270 illustrating the improvement in prediction spaces and optimization spaces that result from using the PHR error loss function to train predictor model 132 are shown, according to an exemplary embodiment. Graph 260 shown in FIG. 14A illustrates the same empirical curve 242 shown in FIG. 11A (i.e., the Octane-Yield curve) with the set of points 252 labeled with x's representing the predictions from predictor model 132 when predictor model 132 is trained without using the PHR loss function (e.g., any of the PHR error loss terms Loss_{PHR-bal}, Loss_{PHR-manip}, Loss_{PHR-grad}, Loss_{PHR-emp}, and/or Loss_{PHR-gain}). It is evident from graph 260 that points 252 do not closely align with empirical curve 242 and deviate more significantly near the lower right side of empirical curve 242.

When predictor model 132 is trained without using the PHR loss function, predictor model 132 learns a relationship between reformate yield and reformate octane represented by prediction space 262. Accordingly, future predictions from predictor model 132 can be located anywhere within prediction space 262. Using these predictions to train predictive controller 136 (i.e., without enforcing the empirical relationship provided by empirical curve 242) results in predictive controller 136 having an optimization space 264. It is evident from graph 260 that a large portion of optimization space 264 deviates significantly from what is realistically achievable based on empirical curve 242. This can be problematic because predictive controller 136 will try to achieve results that are implausible or impossible, leading to suboptimal controller performance and significant deviations in the actual performance of plant 110 relative to the scenario predicted by predictive controller 136.

Graph 270 shown in FIG. 14B illustrates the same empirical curve 242 shown in FIG. 11A (i.e., the Octane-Yield curve) with the set of points 254 labeled with o's representing the predictions from predictor model 132 when predictor model 132 is trained using the PHR loss function (e.g., any of the PHR error loss terms Loss_{PHR-bal}, Loss_{PHR-manip}, Loss_{PHR-grad}, Loss_{PHR-emp}, and/or Loss_{PHR-gain}). Comparing graph 270 to graph 260, it is evident that points 254 more closely align with empirical curve 242 and thus more accurately reflect the actual empirical relationship between variables.

When predictor model 132 is trained using the PHR loss function, predictor model 132 learns a relationship between reformate yield and reformate octane represented by prediction space 272. Accordingly, future predictions from predictor model 132 can be located anywhere within prediction space 272, which more closely matches the shape and location of empirical curve 242. Using these predictions to train predictive controller 136 (i.e., while enforcing the empirical relationship provided by empirical curve 242) results in predictive controller 136 having an optimization space 274. Comparing optimization space 274 in graph 270 to optimization space 264 in graph 260, it is evident that optimization space 274 more closely aligns with empirical curve 242. Accordingly, predictive controller 136 will try to achieve results that physically realistic, leading to improved performance and less error between the scenario predicted by predictive controller 136 and the actual state of plant 110.

### Reward Function Penalties Based on Physical Relationships

Referring again to FIG. 1, in some embodiments, plant controller 120 uses one or more of the PHR error loss terms Loss_{PHR-bal}, Loss_{PHR-manip}, Loss_{PHR-grad}, Loss_{PHR-emp}, and/or Loss_{PHR-gain} described above (referred to individually or collectively as Loss_{PHR}) to impose a penalty on the reward function/used by reward function evaluator 134. The penalty on the reward function/based on Loss_{PHR} can be imposed in addition to using Loss_{PHR} to train predictor model 132 as described above or independently of whether Loss_{PHR} is used to train predictor model 132. For example, in various embodiments Loss_{PHR} can be used to train predictor model 132 but not impose a penalty on the reward function J, Loss_{PHR} can be used to impose a penalty on the reward function/but not train predictor model 132, or Loss_{PHR} can be used to both train predictor model 132 and impose a penalty on the reward function J.

Using Loss_{PHR} to impose a penalty on the reward function/may occur after predictor model 132 has been trained and is being used to predict and/or control operation of plant 110. For example, predictor model 132 may receive the current state of plant 110 and a set of proposed MVs from predictive controller 136 and may generate a set of predicted CVs based on these inputs as shown in FIG. 1. The predicted CVs can be provided to reward function evaluator 134 for use in calculating the value of the reward function/as described above, and can also be provided to prediction error evaluator 142 for use in calculating Loss_{PHR}. Prediction error evaluator 142 can calculate the value of Loss_{PHR} based on the predicted CVs from predictor model 132 and the physical relationships 146 using the same or similar techniques described with reference to FIGS. 1-14B. However, when calculating the value of Loss_{PHR} used to impose a penalty on the reward function J, prediction error evaluator 142 may use the current state of plant 110 and/or predicted future states of the plant in addition to or in place of the historical states of plant 110 from historical database 130. For example, the material balance equations, manipulated states and reactions of plant 110, expected and predicted gradients, empirical data, matrix coefficients, and/or other data used by PHR error evaluator 144 to calculate Loss_{PHR} may be based on the current state of plant 110 and/or predicted future states of plant 110 (e.g., the states otherwise used to evaluate reward function J) when determining the value of the penalty to impose on the reward function J.

Reward function evaluator 134 may impose the penalty on the reward function J by modifying the reward function/to include a penalty based on Loss_{PHR}. The modified reward function can be expressed as follows:

$${J}^{′} = J - λ {Loss}_{PHR}$$

where J is the unmodified reward function as described above, Loss_{PHR} is the penalty based on one or more of the PHR error loss terms Loss_{PHR-bal}, Loss_{PHR-manip}, Loss_{PHR-grad}, Loss_{PHR-emp}, and/or Loss_{PHR-gain}, and λ is a weighting factor used to assign a weight to the penalty Loss_{PHR}. Reward function evaluator 134 can evaluate the modified reward function J′ using the same or similar techniques as described above with respect to the unmodified reward function/and can provide the value of the modified reward function J′ to predictive controller 136 as shown in FIG. 1. Predictive controller 136 may operate in the same manner as described above and may adjust the values of the MVs based on the values of the modified reward function J′ until the modified reward function J′ has been sufficiently optimized.

### Predictor Model Training and Control Process

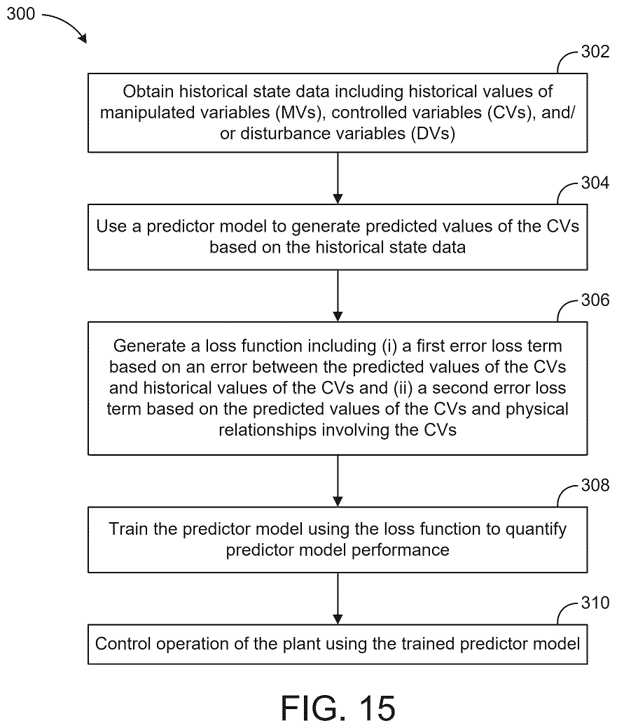

Referring now to FIG. 15, a flowchart of a process 300 for training and using predictor model 132 to control plant 110 is shown, according to an exemplary embodiment. Process 300 can be performed by one or more components of system 100 such as plant controller 120 and the various components thereof (e.g., predictor model trainer 140, predictive controller 136, etc.) as described with reference to FIGS. 1-14B. Process 300 can be used to generate or train (e.g., refine, update, tune, etc.) predictor model 132 and use predictor model 132 to control plant 110. In process 300, predictor model 132 can be trained using any of the various types of physical relationships 146 described above including physical relationships 146 based on material balance principles, manipulated states, expected gradients, and/or empirical data.

Process 300 is shown to include obtaining historical state data including historical values of manipulated variables (MVs), controlled variables (CVs), and/or disturbance variables (DVs) (step 302). The historical state data may define the state of plant 110 at various historical times and/or during various historical time periods (e.g., episodes, time windows, etc.). In some embodiments, the historical state data are obtained from historical database 130. As discussed above, the MVs may include any variables that can be manipulated or adjusted by plant controller 120, for example to cause a desired change in the operation of plant 110. MVs may include control signals that are provided as inputs to equipment 112, setpoints that are provided as inputs to lower level controllers for equipment 112, or other variables that can be directly manipulated (e.g., adjusted, set, modulated, etc.) by plant controller 120. The CVs may include one or more variables that can be controlled by operating equipment 112 of plant 110. In some embodiments, the CVs represent the outputs of plant 110 and are affected by the process represented by plant 110. The CVs may quantify the performance of plant 110 and/or quality of one or more variables affected by plant 110. The DVs may represent disturbances that can cause CVs to deviate from their respective set points or otherwise affect the operation of plant 110. DVs are typically not controllable, but may be measurable or unmeasurable depending on the type of disturbance. Values of the MVs, CVs or DVs can be provided as either the actual values of the corresponding variables or as “MV moves,” “CV moves” or “DV moves” respectively.

Process 300 is shown to include using a predictor model to generate predicted values of the CVs based on the historical state data (step 304). The predictor model used in step 304 may include any of the embodiments of predictor model 132 as described above. For example, the predictor model may be a neural network model, parametric model, state-space model, or any other type of predictive model. Step 304 may include using providing a historical state (e.g., a set of historical values of the MVs, CVs, and/or DVs) or a series of historical states as inputs to the predictor model and generating one or more values of the CVs as outputs of the predictor model. In some embodiments, step 304 includes matching each of the historical states or episodes provided as an input to the predictor model with a corresponding set of CVs provided as outputs of the predictor model.

Process 300 is shown to include generating a loss function including (i) a first error loss term based on an error between the predicted values of the CVs and historical values of the CVs and (ii) a second error loss term based on the predicted values of the CVs and physical relationships involving the CVs (step 306). One example of the loss function is:

$$Loss = {Loss}_{error} + λ {Loss}_{PHR}$$

where Loss is the overall value of the loss function, Lossₑᵣᵣₒᵣ is the first error loss term, Loss_{PHR} is the second error loss term, and λ is a weight (λ>0) used to assign a relative importance to Loss_{PHR} relative to Lossₑᵣᵣₒᵣ. Lossₑᵣᵣₒᵣ may be the loss based on the error in the predicted values of the CVs generated in step 304 relative to the historical values of the CVs (e.g., in historical database 130). Loss_{PHR} may be the loss based on the error in the predicted values of the CVs generated in step 304 relative to expected values of the CVs based on the physical relationships. For embodiments in which multiple physical relationships are considered, the loss function generated in step 306 can be expressed as:

$$Loss = {Loss}_{error} + {λ}_{1} {Loss}_{PHR , 1} + {λ}_{2} {Loss}_{PHR , 2} + {λ}_{3} {Loss}_{PHR , 3} + … + {λ}_{n} {Loss}_{PHR , n}$$

where n is the total number of physical relationships considered and λ₁ . . . λₙ are weights (λ₁ . . . λₙ>0) assigned to their respective PHR error loss terms Loss_{PHR,1} . . . Loss_{PHR,n} to indicate the relative importance of each PHR error loss term in the overall loss function.

In some embodiments, step 306 is performed by predictor model trainer 140 using prediction error evaluator 142 and PHR error evaluator 144 as described with reference to FIGS. 1-12B. The first error loss term in the loss function may be the prediction error loss term Lossₑᵣᵣₒᵣ as described above. Step 306 may include using prediction error evaluator 142 to calculate the prediction error loss term Lossₑᵣᵣₒᵣ using any of a variety of error calculation techniques such as mean squared error (MSE), mean absolute error (MAE), root mean squared error (RMSE), or any other error calculation technique. The second error loss term in the loss function may be the physical relationships error loss term Loss_{PHR} as described above. Step 306 may include using PHR error evaluator 144 to calculate the physical relationships error loss term Loss_{PHR} using any of the techniques described with reference to FIGS. 1-12B. The physical relationships used in step 306 may include any of the physical relationships 146.

In some embodiments, the physical relationships used in step 306 include one or more material balance relationships (e.g., mass balance, volume balance, energy balance, momentum balance, etc.). In such embodiments, step 306 may include using the embodiment of PHR error evaluator 144 shown in FIG. 3 to generate the physical relationships error loss term Loss_{PHR-bal} based on the material balance relationships. For example, step 306 may include using material balance generator 152 to generate one or more material balance equations expressing conservation of a physical quantity (e.g., mass, volume, energy, momentum, etc.) represented by one or more of the CVs and one or more other variables (e.g., other CVs, MVs, DVs, etc.). Step 306 may include calculating a value of the second error loss term Loss_{PHR-bal} based on an amount by which the predicted values of the CVs violate the material balance equations. This portion of step 306 may be performed by material balance error calculator 154 as described above.

In some embodiments, the physical relationships used in step 306 include correlations between the CVs and the MVs and/or DVs (e.g., positive correlations, negative correlations, etc.). These types of physical relationships may indicate whether increasing or decreasing a given MV or DV is expected to result in a corresponding increase or decrease in a predicted CV. In such embodiments, step 306 may include using the embodiment of PHR error evaluator 144 shown in FIG. 6 to generate the physical relationships error loss term Loss_{PHR-manip} based on manipulated states. For example, step 306 may include using manipulated state generator 156 to generate a manipulated state of plant 110 as described with reference to FIG. 6. The manipulated state may include one or more adjusted values of the MVs relative to the historical values of the MVs. Step 306 may include using the predictor model to generate a predicted reaction to the manipulated state. The predicted reaction may include one or more new predicted values of the CVs based on the adjusted values of the MVs in the manipulated state. Step 306 may include calculating a value of the second error loss term Loss_{PHR-manip} based on whether the predicted reaction to the manipulated state is consistent with the correlations defined by the physical relationships. In some embodiments, step 306 includes using the relu function or any other function to penalize predicted reactions that do not cause the predicted values of the CVs to move (i.e., increase or decrease) in the direction indicated by the correlation provided by the physical relationships.

In some embodiments, the physical relationships used in step 306 include one or more gradients involving the CVs. In such embodiments, step 306 may include using the embodiment of PHR error evaluator shown in FIG. 8 to generate the second error loss term Loss_{PHR-grad}. For example, step 306 may include using gradient generator 160 to generate one or more expected gradients based on the physical relationships. Each expected gradient may include a gradient between a CV and another variable upon which the CV depends (e.g., a MV, DV, or another CV) according to the physical relationships. Step 306 may include using predictor model 132 and the historical state data to generate one or more predicted gradients. Each predicted gradient may include a gradient between the predicted values of a CV generated by predictor model 132 and historical values of another variable in the historical state data (e.g., a MV, DV, or another CV). Step 306 may include calculating a value of the second error loss term Loss_{PHR-grad} based on whether the one or more predicted gradients are consistent with the one or more expected gradients based on the physical relationships. In some embodiments, step 306 includes using the relu function or any other function to penalize predicted gradients that do not have the same sign (i.e., positive or negative) as the corresponding expected gradients indicated base indicated by the physical relationships. In some embodiments, step 306 includes using gradient error calculator 162 to calculate the value of Loss_{PHR-grad} as described above, based on whether the predicted gradient has the same sign as the expected gradient and/or has a value that exceeds or is less than the expected gradient.

In some embodiments, the physical relationships used in step 306 include one or more empirical relationships involving the CVs. In such embodiments, step 306 may include using the embodiment of PHR error evaluator shown in FIG. 10 to generate the second error loss term Loss_{PHR-emp} based on empirical relationships. Step 306 may include obtaining empirical data including observed or calculated values of one or more of the CVs and one or more other variables (e.g., MVs, DVs, or other CVs). Step 306 may include using empirical curve generator 164 to generate one or more empirical curves based on the empirical data. Each empirical curve may define an empirically derived relationship between one or more of the CVs and the one or more other variables. One example of such an empirical curve is the Octane-Yield curve shown in FIGS. 11A-11B. Step 306 may include calculating a value of the second error loss term Loss_{PHR-emp} based on an error between the predicted values of the CVs generated by the predictor model and the one or more empirical curves. This portion of step 306 may be performed by distance error calculator 166 as described with reference to FIGS. 10-11B.

In some embodiments, the physical relationships used in step 306 include one or more relationships involving the matrix coefficients of gains matrix 168. In such embodiments, step 306 may include using the embodiment of PHR error evaluator shown in FIG. 13 to generate the second error loss term Loss_{PHR-gain} based on relationships involving the matrix coefficients. Step 306 may include training predictor model 132 to generate gains matrix 168 and obtaining values of the matrix coefficients from gains matrix 168. Step 306 may include using gain generator 170 to generate one or more gain equations based on the physical relationships 146. Each gain equation may indicate an expected relationship between the matrix coefficients of gains matrix 168, based on the physical relationships between the corresponding MVs, CVs, and DVs. Step 306 may include calculating a value of the second error loss term Loss_{PHR-gain} based on the actual values of the matrix coefficients obtained from gains matrix 168 and the expected values of the matrix coefficients defined by the gain equations. This portion of step 306 may be performed by gain error calculator 172 as described with reference to FIG. 13.

Process 300 is shown to include training the predictor model using the loss function quantify predictor model performance (step 308). Step 308 can be performed by predictor model trainer 140 using model tuner 150, as described with reference to FIG. 2. For example, step 308 can include calculating the value of the loss function Loss using the various terms generated in step 306 and providing the value of the loss function to model tuner 150. Step 308 can include using any of a variety of model tuning techniques to adjust the weights of the predictor model in an effort to minimize the value of the overall loss function Loss. In some embodiments, step 308 uses an iterative tuning process that includes adjusting the weights and/or biases of the predictor model, using the predictor model to generate the predicted values of the CVs, and evaluating the loss function Loss for each set of values of the weights. Step 308 can be repeated iteratively and can continue adjusting the model weights using an iterative optimization technique (e.g., gradient descent) until the resulting value of the loss function Loss is sufficiently small or has been minimized according to predetermined optimization criteria (e.g., convergence criteria).

Process 300 is shown to include controlling operation of the plant using the trained predictor model (step 310). In some embodiments, step 310 is performed by predictive controller 136 as previously described. Step 310 may include operating equipment 112 of plant 110 using new values of the MVs generated by predictive controller 136 using the trained predictor model. In some embodiments, the new values of the MVs are generated by performing predictive control process or predictive optimization process. For example, step 310 may include providing proposed values of the MVs as an input to the trained predictor model and using the trained predictor model to generate new predicted values of the CVs based on the proposed values of the MVs. In some embodiments, step 310 includes using the PHR error loss Loss_{PHR} to impose a penalty on the reward function/to generate a modified reward function J′ as described above. Step 310 may include using reward function evaluator 134 to evaluate the reward function/or the modified reward function J′ based on the new predicted values of the CVs (and optionally one or more MVs and/or DVs). Step 310 may include adjusting the proposed values of the MVs (e.g., iteratively) to drive the reward function/or the modified reward function J′ toward an extremum (i.e., a maximum or minimum).

### CONFIGURATION OF EXEMPLARY EMBODIMENTS

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A predictive control system for a plant, the predictive control system comprising:
a predictor model trainer configured to:
obtain historical state data comprising at least historical values of one or more manipulated variables (MVs) provided as inputs to the plant and historical values of one or more controlled variables (CVs) affected by operating the plant using the historical values of the MVs;
use a predictor model to generate predicted values of the CVs based on the historical state data;
generate a loss function comprising (i) a first error loss term based on an error between the predicted values of the CVs and the historical values of the CVs in the historical state data and (ii) a second error loss term based on the predicted values of the CVs and physical relationships involving the CVs; and
train the predictor model using the loss function, wherein training the predictor model comprises adjusting the predictor model to drive the loss function toward an extremum and transforms the predictor model into a trained predictor model; and
a predictive controller configured to control operation of the plant using the trained predictor model.

2. The predictive control system of claim 1, wherein controlling operation of the plant comprises operating equipment of the plant using new values of the MVs generated by the predictive controller using the trained predictor model.

3. The predictive control system of claim 1, wherein controlling operation of the plant comprises:
providing proposed values of the MVs as an input to the trained predictor model;
using the trained predictor model to generate new predicted values of the CVs based on the proposed values of the MVs;
evaluating a reward function using the new predicted values of the CVs; and
adjusting the proposed values of the MVs to drive the reward function toward an extremum.

4. The predictive control system of claim 1, wherein the physical relationships involving the CVs comprise one or more material balance relationships and the predictor model trainer is configured to generate the second error loss term by:
generating one or more material balance equations expressing conservation of a physical quantity represented by one or more of the CVs and one or more other variables;
calculating a value of the second error loss term based on an amount by which the predicted values of the CVs violate the material balance equations.

5. The predictive control system of claim 1, wherein the physical relationships involving the CVs comprise one or more correlations between the MVs and the CVs and the predictor model trainer is configured to generate the second error loss term by:
generating a manipulated state of the plant comprising one or more adjusted values of the MVs relative to the historical values of the MVs;
using the predictor model to generate a predicted reaction to the manipulated state, the predicted reaction comprising one or more new predicted values of the CVs based on the adjusted values of the MVs; and
calculating a value of the second error loss term based on whether the predicted reaction to the manipulated state is consistent with the one or more correlations defined by the physical relationships.

6. The predictive control system of claim 1, wherein the physical relationships involving the CVs comprise one or more gradients involving the CVs and the predictor model trainer is configured to generate the second error loss term by:
generating one or more expected gradients based on the physical relationships, each expected gradient comprising a gradient between a CV and another variable upon which the CV depends according to the physical relationships;
generating one or more predicted gradients based on the predicted values of the CVs generated by the predictor model and the historical state data, each predicted gradient comprising a gradient between the predicted values of a CV and historical values of another variable in the historical state data; and
calculating a value of the second error loss term based on whether the one or more predicted gradients are consistent with the one or more expected gradients based on the physical relationships.

7. The predictive control system of claim 1, wherein the physical relationships involving the CVs comprise empirical relationships involving the CVs and the predictor model trainer is configured to generate the second error loss term by:
obtaining empirical data comprising observed or calculated values of one or more of the CVs and one or more other variables;
generating one or more empirical curves based on the empirical data, each empirical curve defining an empirically derived relationship between one or more of the CVs and the one or more other variables; and
calculating a value of the second error loss term based on an error between the predicted values of the CVs generated by the predictor model and the one or more empirical curves.

8. The predictive control system of claim 1, wherein the predictor model is a neural network model and training the predictor model comprises adjusting weights or biases between neurons or layers of the neural network model.

9. A method for controlling operation of a plant, the method comprising:
training a predictor model using historical state data comprising at least historical values of one or more manipulated variables (MVs) provided as inputs to the plant and historical values of one or more controlled variables (CVs) affected by operating the plant using the historical values of the MVs;
using the predictor model to generate predicted values of the CVs based on proposed values of the MVs;
generating a reward function comprising (i) a first reward term based on the predicted values of the CVs and (ii) a second reward term based on physical relationships involving the CVs;
adjusting the proposed values of the MVs to generate new values of the MVs that drive the reward function toward an extremum; and
controlling operation of the plant using the new values of the MVs.

10. The method of claim 9, wherein training the predictor model comprises using the predictor model to generate additional predicted values of the CVs based on the historical state data.

11. The method of claim 10, wherein training the predictor model further comprises:
generating a loss function comprising (i) a first error loss term based on an error between the additional predicted values of the CVs and the historical values of the CVs in the historical state data and (ii) a second error loss term based on the additional predicted values of the CVs and the physical relationships involving the CVs; and
adjusting parameters of the predictor model to drive the loss function toward an extremum.

12. The method of claim 9, wherein the physical relationships involving the CVs comprise one or more material balance relationships and generating the second reward term comprises:
generating one or more material balance equations expressing conservation of a physical quantity represented by one or more of the CVs and one or more other variables;
calculating a value of the second reward term based on an amount by which the predicted values of the CVs violate the material balance equations.

13. The method of claim 9, wherein the physical relationships involving the CVs comprise one or more correlations between the MVs and the CVs and generating the second reward term comprises:
generating a manipulated state of the plant comprising one or more adjusted values of the MVs relative to the historical values of the MVs;
using the predictor model to generate a predicted reaction to the manipulated state, the predicted reaction comprising one or more new predicted values of the CVs based on the adjusted values of the MVs; and
calculating a value of the second reward term based on whether the predicted reaction to the manipulated state is consistent with the one or more correlations defined by the physical relationships.

14. The method of claim 9, wherein the physical relationships involving the CVs comprise one or more gradients involving the CVs and generating the second reward term comprises:
generating one or more expected gradients based on the physical relationships, each expected gradient comprising a gradient between a CV and another variable upon which the CV depends according to the physical relationships;
generating one or more predicted gradients based on the predicted values of the CVs generated by the predictor model and the historical state data, each predicted gradient comprising a gradient between the predicted values of a CV and historical values of another variable in the historical state data; and
calculating a value of the second reward term based on whether the one or more predicted gradients are consistent with the one or more expected gradients based on the physical relationships.

15. The method of claim 9, wherein the physical relationships involving the CVs comprise empirical relationships involving the CVs and generating the second reward term comprises:
obtaining empirical data comprising observed or calculated values of one or more of the CVs and one or more other variables;
generating one or more empirical curves based on the empirical data, each empirical curve defining an empirically derived relationship between one or more of the CVs and the one or more other variables; and
calculating a value of the second reward term based on an error between the predicted values of the CVs generated by the predictor model and the one or more empirical curves.

16. The method of claim 9, wherein the predictor model is a neural network model and training the predictor model comprises adjusting weights or biases between neurons or layers of the neural network model.

17. A predictive control system for a plant, the predictive control system comprising one or more processing circuits configured to:
obtain historical state data comprising at least historical values of one or more manipulated variables (MVs) provided as inputs to the plant and historical values of one or more controlled variables (CVs) affected by operating the plant using the historical values of the MVs;
use a neural network predictor to generate predicted values of the CVs based on the historical state data;
generate a loss function comprising (i) a first error loss term based on an error between the predicted values of the CVs and the historical values of the CVs in the historical state data and (ii) a second error loss term based on the predicted values of the CVs and physical relationships involving the CVs;
train the neural network predictor using the loss function, wherein training the neural network predictor comprises adjusting the neural network predictor to drive the loss function toward an extremum and transforms the neural network predictor into a trained neural network predictor; and
use the trained neural network predictor to monitor or control operation of the plant.

18. The predictive control system of claim 17, wherein the physical relationships involving the CVs comprise one or more material balance relationships and the one or more processing circuits are configured to generate the second error loss term by:
generating one or more material balance equations expressing conservation of a physical quantity represented by one or more of the CVs and one or more other variables;
calculating a value of the second error loss term based on an amount by which the predicted values of the CVs violate the material balance equations.

19. The predictive control system of claim 17, wherein the physical relationships involving the CVs comprise one or more correlations between the MVs and the CVs and the one or more processing circuits are configured to generate the second error loss term by:
generating a manipulated state of the plant comprising one or more adjusted values of the MVs relative to the historical values of the MVs;
using the neural network predictor to generate a predicted reaction to the manipulated state, the predicted reaction comprising one or more new predicted values of the CVs based on the adjusted values of the MVs; and
calculating a value of the second error loss term based on whether the predicted reaction to the manipulated state is consistent with the one or more correlations defined by the physical relationships.

20. The predictive control system of claim 17, wherein the physical relationships involving the CVs comprise one or more gradients involving the CVs and the one or more processing circuits are configured to generate the second error loss term by:
generating one or more expected gradients based on the physical relationships, each expected gradient comprising a gradient between a CV and another variable upon which the CV depends according to the physical relationships;
generating one or more predicted gradients based on the predicted values of the CVs generated by the neural network predictor and the historical state data, each predicted gradient comprising a gradient between the predicted values of a CV and historical values of another variable in the historical state data; and
calculating a value of the second error loss term based on whether the one or more predicted gradients are consistent with the one or more expected gradients based on the physical relationships.

21. The predictive control system of claim 17, wherein the physical relationships involving the CVs comprise empirical relationships involving the CVs and the one or more processing circuits are configured to generate the second error loss term by:
obtaining empirical data comprising observed or calculated values of one or more of the CVs and one or more other variables;
generating one or more empirical curves based on the empirical data, each empirical curve defining an empirically derived relationship between one or more of the CVs and the one or more other variables; and
calculating a value of the second error loss term based on an error between the predicted values of the CVs generated by the neural network predictor and the one or more empirical curves.
